(19) United States
(12) Patent Application Publication
(10) Pub. No.: US 2006/0093786 A1
(43) Pub. Date: May 4, 2006

(54) Silica-containing laminated structure, and coating composition for use in forming a porous silica layer

(76) Inventors: Toshihiko Ohashi, Fuji-shi (JP); Jun Li, Fuji-shi (JP); Takaaki Ioka, Fuji-shi (JP)

Correspondence Address: BIRCH STEWART KOLASCH & BIRCH, PO BOX 747, FALLS CHURCH, VA, 22040-0747, US

(21) Appl. No.: 10/541,776

(22) PCT Filed: Feb. 20, 2004
(86) PCT No.: PCT/JP04/02012

§ 371 Date: Jul. 8, 2005

(51) Int. Cl. B32B 3/10

(52) U.S. Cl. 428/131

(57) ABSTRACT

A silica-containing laminated structure comprising a transparent thermoplastic resin substrate and, laminated thereon, at least one porous silica layer having a refractive index of 1.22 or more and less than 1.30, wherein the at least one porous silica layer is comprised of a plurality of moniliform silica strings, each comprising a plurality of primary silica particles which are linked in rosary form, and wherein the pores of the at least one porous silica layer include pores (P), each of pores (P) having a pore opening area which is larger than the average value of the respective maximum cross-sectional areas of the primary silica particles, wherein the pore opening areas of pores (P) are measured with respect to the pore openings in the surface or cross-section of the porous silica layer.

### BACKGROUND OF THE INVENTION

1. Field of the Invention

The present invention relates to a silica-containing laminated structure. More particularly, the present invention is concerned with a silica-containing laminated structure comprising a transparent thermoplastic resin substrate and, laminated thereon, at least one porous silica layer having a refractive index of 1.22 or more and less than 1.30, wherein the at least one porous silica layer is comprised of a plurality of moniliform silica strings, each comprising a plurality of primary silica particles which are linked in rosary form, and wherein the pores of the at least one porous silica layer include pores having specific sizes. The silica-containing laminated structure of the present invention is advantageous in that the porous silica layer has not only low refractivity and high light transmittance but also high strength, so that the silica-containing laminated structure can be advantageously used as an antireflection material, such as an antireflection film. The present invention is also concerned with a coating composition for use in forming on a substrate a porous silica layer having low refractivity and concerned with an antireflection film which is formed using the above-mentioned coating composition, wherein the formed antireflection film comprises a porous silica layer having low refractivity.

2. Prior Art

Conventionally, as an antireflection film for coating an optical part, lenses of eye-glasses, a display screen or the like, there are known an antireflection film having a single-silica-layer structure and an antireflection film having a silica multilayer structure. An antireflection film having a single-silica-layer structure or a double-silica-layer structure has disadvantageously high reflectance. Therefore, it has been considered to be more desirable to use an antireflection film having a laminated structure comprised of three or more different silica layers having different refractive indices. However, when such an antireflection film comprised of three or more different silica layers is produced by any of the conventional methods, such as vacuum deposition and dip coating, disadvantages are caused in that the production process is cumbersome and also the productivity is low.

Therefore, studies have been made on antireflection films having a single-silica-layer structure, and it has been found that the refractivity of such a single-silica-layer antireflection film can be reduced when the antireflection film satisfies the conditions mentioned below. Thus, studies have been made for developing a single-silica-layer film which satisfies such conditions. Specifically, it is known that, in the case of an antireflection film comprising a substrate and, formed thereon, a single-silica-layer film, the minimum value of the reflectance R of the antireflection film can be expressed by the formula: (nₛ−n²)²/(nₛ+n²)², wherein nₛ represents the refractive index of the substrate and n represents the refractive index of the single-silica-layer film, with the proviso that nₛ>n. Therefore, it has been attempted to reduce the reflectance R by adjusting the refractive index n of the single-silica-layer film to a value which is as close as possible to nₛ^{1/2} so that n² and nₛ become as close as possible to each other.

More specifically, when a conventional transparent substrate having a refractive index nₛ of from 1.49 to 1.67 (e.g., glass (nₛ=about 1.52), polymethyl methacrylate (nₛ=about 1.49), polyethylene terephthalate (hereinafter, frequently referred to as “PET”) (nₛ=about 1.54 to 1.67) or triacetyl cellulose (nₛ=about 1.49)) is used, the appropriate refractive index n of the single-silica-layer film is within the range of from 1.22 to 1.30. That is, by adjusting the refractive index n of the single-silica-layer film to an appropriate value within the range of from 0.1.22 to 1.30 depending on the refractive index nₛ of the transparent substrate used, there can be obtained a satisfactory antireflection film even with a single-silica-layer film.

For achieving a refractive index n of the single-silica-layer film within the above-mentioned range, there has been proposed a porous single-silica-layer film which is obtained by a method comprising introducing a pore-forming agent into a film and extracting the pore-forming agent from the film to thereby form pores in the film (see, for example, Unexamined Japanese Patent Application Laid-Open Specification Nos. Hei 1-312501, Hei 7-140303, Hei 3-199043 and Hei 11-35313). However, the above-mentioned porous film has the following problems. When the pore-forming agent is extracted from the film, the film is swollen or is delaminated from the substrate. Further, the production process becomes cumbersome.

Therefore, there have been proposed various porous single-silica-layer films having a low refractivity, which can be obtained by a method not involving an extraction step. Specifically, there has been proposed a porous single-silica-layer film which is obtained by a method in which inorganic particles which are linked in a chain form (hereinafter referred to as “chain-like inorganic substance”) are treated with a silane coupling agent, followed by addition of a binder (e.g., a photocurable acrylate) to obtain a coating liquid, and the obtained coating liquid is coated on a substrate, thereby obtaining a porous single-silica-layer film (see, for example, Unexamined Japanese Patent Application Laid-Open Specification No. 2001-188104). However, this porous single-silica-layer film poses a problem in that the pores become filled with the binder added for reinforcing the film, so that a satisfactorily low refractive index cannot be achieved.

There has also been proposed a porous single-silica-layer film which is obtained by using a specific coating liquid which is produced by adding polysiloxane, as a binder, to silica particles which are linked in a chain form (hereinafter referred to as “chain-like silica”) (see, for example, Unexamined Japanese Patent Application Laid-Open Specification Nos. Hei 11-61043 and Hei 11-292568). However, for achieving a satisfactory strength of the film by performing the dehydration-condensation reaction between the hydroxyl groups of the chain-like silica and the hydroxyl groups of the polysiloxane, a heat treatment at a temperature as high as 300° C. or more is required. Therefore, in this method, only highly heat-resistant substrates, such as glass substrates can be used, and transparent thermoplastic resin substrates, which have low heat resistance, cannot be used.

Further, there has been proposed an antireflection film having a refractive index in the range of from 1.28 to 1.38, the film being obtained by coating, on a substrate, a composition comprising a hydrolysis product of an alkoxysilane and/or a hydrolysis product of a metal alkoxide and silica particles having a particle diameter in the range of from 5 to 30 nm, followed by curing (see Unexamined Japanese Patent Application Laid-Open Specification No. Hei 8-122501). This patent document describes that moniliform silica strings may be used as silica particles, and that a thermoplastic resin substrate may be used as a substrate. Further, this patent document has a working example in which a single-silica-layer film is formed on a thermoplastic resin substrate. However, in this working example, silica particles used are not moniliform silica strings, but separate, non-linked silica particles (particle diameter: 15 nm). The refractive index of the single-silica-layer film obtained in this working example is disadvantageously as high as 1.32 and, hence, such a single-silica-layer film cannot exhibit a satisfactory antireflection effect. Furthermore, this patent document has another working example in which a single-silica-layer film having a refractive index of less than 1.30 is formed on a silicon substrate by using separate, non-linked silica particles (particle diameter: 15 nm). The silica particles used in this working example are produced by subjecting tetraethoxysilane to hydrolysis and condensation in the presence of an ammonia catalyst. It is generally known that silica particles produced by subjecting tetraethoxysilane to hydrolysis and condensation in the presence of a basic catalyst have low density and have a great number of minute pores in the inner portion thereof (see Japanese Patent No. 3272111 and pages 61 to 62 of “Zorugeruhou no gijututekikadai to sono taisaku (Technical problems of sol-gel method and solutions therefor)”, published by Industrial Publishing & Consulting, Inc., Japan, 1990). It is easy to produce a single-silica-layer film having a low refractivity from such silica particles which have low density; however, such low-density silica particles have poor strength, so that the strength of the single-silica-layer film produced therefrom becomes inevitably poor. In this working example, after the single-silica-layer film is formed, the film is heated at 300° C. in order to increase the strength of the film. Therefore, in the method of this working example, it is impossible to use a thermoplastic resin substrate (which has poor heat resistance). Thus, an antireflection film (using a thermoplastic resin substrate) which has satisfactory strength for practical use is not provided in this patent document.

As apparent from the above, in the prior art, it is impossible to obtain an antireflection laminated structure comprising a transparent thermoplastic resin substrate and a porous silica layer, wherein the porous silica layer has not only satisfactorily low refractivity, but also excellent mechanical strength.

### SUMMARY OF THE INVENTION

In this situation, the present inventors have made extensive and intensive studies with a view toward solving the above-mentioned problems accompanying the prior art. As a result, it has unexpectedly been found that, by the use of a specific coating composition (containing moniliform silica strings, each comprising a plurality of primary silica particles linked in rosary form) prepared by a specific method, there can be obtained a silica-containing laminated structure which comprises a transparent thermoplastic resin substrate and, laminated thereon, a porous silica layer which has not only a refractive index as low as from 1.22 or more to less than 1.30 and high light transmittance, but also excellent mechanical strength. The porous silica layer of the laminated structure comprises a plurality of moniliform silica strings, each comprising a plurality of primary silica particles which are linked in rosary form, wherein the pores of the porous silica layer include pores (P), each of the pores (P) having a pore opening area which is larger than the average value of the respective maximum cross-sectional areas of the primary silica particles (wherein the pore opening areas of the pores (P) are measured with respect to the pore openings in the surface or cross-section of the porous silica layer). The above-mentioned specific coating composition comprises a product which is obtained by a method comprising: mixing a dispersion of moniliform silica strings with a hydrolyzable group-containing silane to obtain a mixture, wherein each of the moniliform silica strings comprises a plurality of primary silica particles which are linked in rosary form; and subjecting the obtained mixture to hydrolysis and dehydration-condensation. The present invention has been completed based on this novel finding.

Accordingly, an object of the present invention is to provide a silica-containing laminated structure comprising a transparent thermoplastic resin substrate and, laminated thereon, a porous silica layer having not only a low refractive index of 1.22 or more and less than 1.30 and high light transmittance, but also excellent mechanical strength, the laminated structure being able to be advantageously used as an antireflection material.

Another object of the present invention is to provide a coating composition for use in forming, even on a transparent thermoplastic resin substrate having poor heat resistance, a porous silica layer having not only low refractivity and high light transmittance, but also excellent mechanical strength.

Still another object of the present invention is to provide an antireflection film comprising a porous silica layer having low refractivity, which is formed by using the above-mentioned coating composition.

The foregoing and other objects, features and advantages of the present invention will be apparent from the following description taken in connection with the accompanying drawings and appended claims.

### BRIEF DESCRIPTION OF THE DRAWINGS

In the drawings:

FIG. 1 is a photograph showing the appearance of a coating formed from the coating composition obtained in Example 17, wherein the coating composition contained nitric acid in a concentration of 0.0010 mol/liter;

FIG. 2 is a photograph showing the appearance of a coating formed from the coating composition obtained in Example 18, wherein the coating composition contained nitric acid in a concentration of 0.0020 mol/liter;

FIG. 3 is a photograph showing the appearance of a coating formed from the coating composition obtained in Example 19, wherein the coating composition contained nitric acid in a concentration of 0.0035 mol/liter;

FIG. 4 is a photograph showing the appearance of a coating formed from the coating composition obtained in Example 20, wherein the coating composition contained nitric acid in a concentration of 0.0050 mol/liter;

FIG. 5 is a photomicrograph (taken using a scanning electron microscope) of the porous silica layer obtained in Example 21, wherein the porous silica layer was formed by coating on a PET substrate a coating composition containing moniliform silica strings, and heating the resultant coating on the PET substrate at 120° C.;

FIG. 6 is a graph showing the distribution of pore opening areas, the graph being obtained by an image analysis of the photomicrograph of FIG. 5;

FIG. 7 is a photomicrograph (taken using a scanning electron microscope) of the porous silica layer obtained in Comparative Example 6, wherein the porous silica layer was formed by coating on a glass substrate a coating composition containing moniliform silica strings, and heating the resultant coating on the glass substrate several times at different temperatures up to 500° C.;

FIG. 8 is a graph showing the distribution of pore opening areas, the graph being obtained by an image analysis of the photomicrograph of FIG. 7;

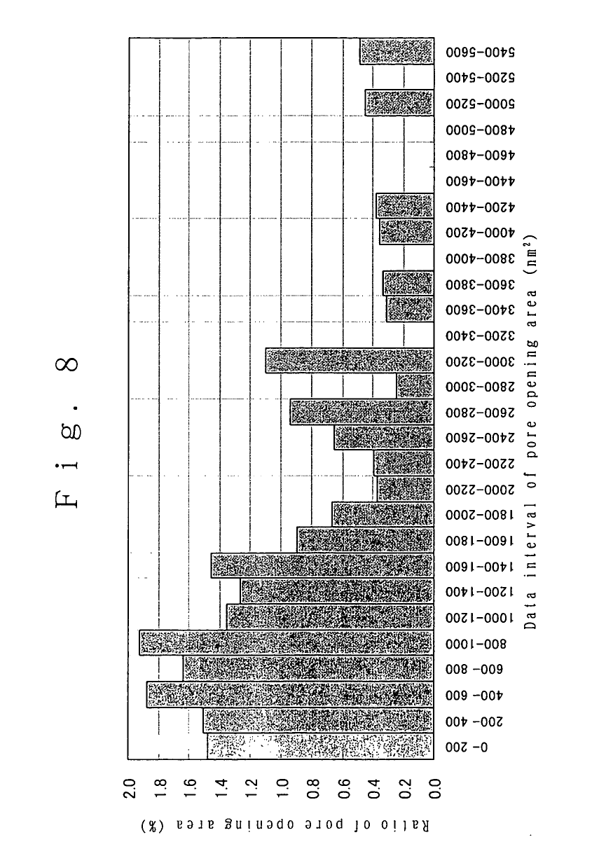

FIG. 9 is a photomicrograph (taken using a scanning electron microscope) of the porous silica layer obtained in Comparative Example 7, wherein the porous silica layer was formed by coating on a PET substrate a coating composition containing separate, non-linked silica particles, and heating the resultant coating on the PET substrate at 120° C.; and

FIG. 10 is a graph showing the distribution of pore opening areas, the graph being obtained by an image analysis of the photomicrograph of FIG. 9.

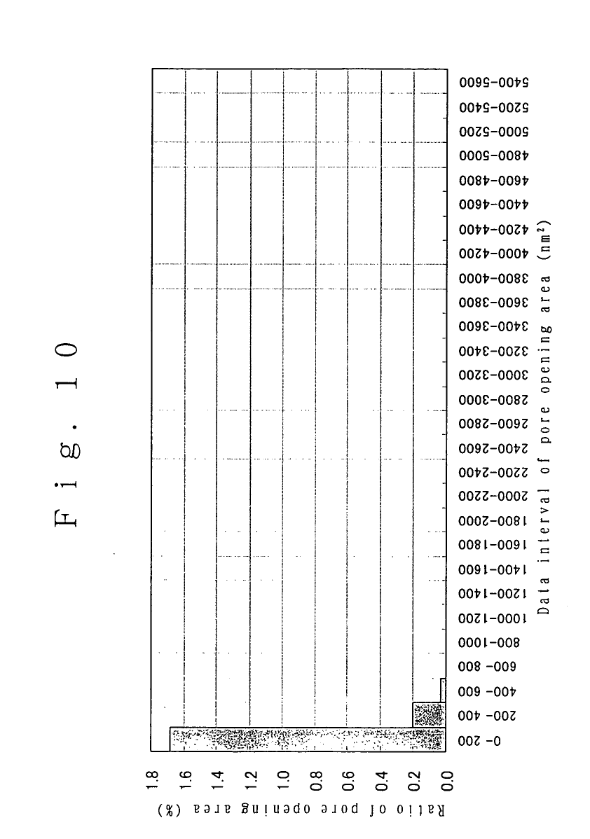

### DETAILED DESCRIPTION OF THE INVENTION

In one aspect of the present invention, there is provided a silica-containing laminated structure comprising a transparent thermoplastic resin substrate and, laminated thereon, at least one porous silica layer having a refractive index of 1.22 or more and less than 1.30,

wherein the at least one porous silica layer is comprised of a plurality of moniliform silica strings, each comprising a plurality of primary silica particles which are linked in rosary form, and

wherein the pores of the at least one porous silica layer include pores (P), each of the pores (P) having a pore opening area which is larger than the average value of the respective maximum cross-sectional areas of the primary silica particles, wherein the pore opening areas of the pores (P) are measured with respect to the pore openings in the surface or cross-section of the porous silica layer.

For an easy understanding of the present invention, the essential features and various preferred embodiments of the present invention are enumerated below.

1. A silica-containing laminated structure comprising a transparent thermoplastic resin substrate and, laminated thereon, at least one porous silica layer having a refractive index of 1.22 or more and less than 1.30,

wherein the at least one porous silica layer is comprised of a plurality of moniliform silica strings, each comprising a plurality of primary silica particles which are linked in rosary form, and

wherein the pores of the at least one porous silica layer include pores (P), each of the pores (P) having a pore opening area which is larger than the average value of the respective maximum cross-sectional areas of the primary silica particles, wherein the pore opening areas of the pores (P) are measured with respect to the pore openings in the surface or cross-section of the porous silica layer.

2. The silica-containing laminated structure according to item 1 above, wherein the moniliform silica strings have an average length of from 30 to 200 nm in terms of the average value as measured by the dynamic light scattering method.

3. The silica-containing laminated structure according to item 1 or 2 above, wherein the amount of silicon atoms present in the moniliform silica strings is 15% or more, based on the total number of silicon atoms present in the at least one porous silica layer.

4. The silica-containing laminated structure according to any one of items 1 to 3 above, wherein a part or all of the pores (P) have their respective pore opening areas (a₁), each of the pore opening areas (a₁) being independently at least 3σ larger than the average value (a₂) of the respective maximum cross-sectional areas of the primary silica particles, wherein the pore opening areas (a₁) are measured with respect to the pore openings in the surface or cross-section of the porous silica layer, and wherein a represents the standard deviation of the measured values of the maximum cross-sectional areas of the primary silica particles, and

wherein the total (S_{(a2+3σ)}) of the pore opening areas (a₁) of the pores (P) and the total (S) of pore opening areas of all pores of the porous silica layer as measured with respect to the pore openings in the surface or cross-section of the porous silica layer satisfy the following formula (1):
(S_{(a2+3σ)})/(S)≧0.5 (1).
5. The silica-containing laminated structure according to any one of items 1 to 4 above, wherein the transparent thermoplastic resin substrate has a pencil hardness of from 1H to 8H.
6. The silica-containing laminated structure according to any one of items 1 to 5 above, which further comprises a hard coat layer having a water contact angle of 85° or less between the transparent thermoplastic resin substrate and the porous silica layer.
7. A coating composition for use in forming on a substrate a porous silica layer having a low refractivity, which comprises a product obtained by a method comprising:

mixing a dispersion of moniliform silica strings with a hydrolyzable group-containing silane to obtain a mixture, wherein each of the moniliform silica strings comprises a plurality of primary silica particles which are linked in rosary form, and

subjecting the obtained mixture to hydrolysis and dehydration-condensation.

8. The coating composition according to item 7 above, wherein the moniliform silica strings have an average length of from 30 to 200 nm in terms of the average value as measured by the dynamic light scattering method.

9. The coating composition according to item 7 or 8 above, wherein the molar ratio of the hydrolyzable group-containing silane to the silicon atoms present in the moniliform silica strings is from 0.005 to 1.0.

10. The coating composition according to any one of items 7 to 9 above, which further comprises at least one alkaline earth metal salt.

11. The coating composition according to item 10 above, wherein the molar ratio of the at least one alkaline earth metal salt to the silicon atoms present in the moniliform silica strings is from 0.001 to 0.1.

12. The coating composition according to any one of items 7 to 11 above, which further comprises an acid in a concentration of 0.0008 mol/liter or more, and which has a water content of more than 1.5 parts by weight, per part by weight of the moniliform silica strings.

13. An antireflection film comprising at least one porous silica layer having a low refractivity, which is formed by using the coating composition of any one of items 7 to 12 above.

14. An antireflection film comprising the silica-containing laminated structure of any one of items 1 to 6 above, the silica-containing laminated structure comprising a transparent thermoplastic resin substrate and, laminated thereon, at least one porous silica layer having a refractive index of 1.22 or more and less than 1.30,

wherein the at least one porous silica layer contained in the silica-containing laminated structure is formed by using the coating composition of items 7 to 12 above.

Hereinbelow, the present invention is described in detail.

The silica-containing laminated structure of the present invention comprises a transparent thermoplastic resin substrate and, laminated thereon, at least one porous silica layer having a refractive index of 1.22 or more and less than 1.30.

In the present invention, it is preferred that the transparent thermoplastic resin substrate is a film which is transparent to visible light. Examples of such films include cellulose acetate-type films, such as a triacetyl cellulose film and a cellulose acetate propionate film; polyester films, such as a stretched polyethylene terephthalate film and a stretched polyethylene naphthalate film; polycarbonate films; norbornene films; polyarylate films and polysulfone films. Alternatively, as a transparent thermoplastic resin substrate, a sheet or board (which are thicker than the above-mentioned film) may be used. Examples of such sheets or boards include sheets or boards of polyalkyl methacrylate, polyalkyl acrylate and polycarbonate.

The heat distortion temperature of the transparent thermoplastic resin substrate is preferably 60° C. or more, more preferably 70° C. or more, still more preferably 80° C. or more. When the heat distortion temperature is lower than 60° C., the heating temperature for the formation of the porous silica layer is necessarily low, possibly leading to problems that the mechanical strength of the porous silica layer becomes unsatisfactory and that the long-term environmental stability of the transparent thermoplastic resin substrate becomes unsatisfactory.

When the transparent thermoplastic resin substrate is a film, the thickness thereof is preferably from 1 to 500 μm, more preferably from 30 to 300 μm, most preferably from 50 to 200 μm. A film having a thickness of less than 1 μm does not have satisfactory strength for practical use. On the other hand, a film having a thickness of more than 500 μm poses a problem, for example, in that it is difficult to form the film into a roll, thus rendering it difficult to employ a continuous coating process. When the transparent thermoplastic resin substrate is a sheet or a board, there is no particular limitation with respect to the thickness of the substrate, so long as the substrate has satisfactory light transmittance and strength which are required for the specific use of the laminated structure.

It is preferred that the transparent thermoplastic resin substrate exhibits a light transmittance of 80% or more, more advantageously 85% or more, at a wavelength of 550 nm. Further, it is preferred that the haze of the substrate is not more than 2.0%, more advantageously not more than 1.0%. The refractive index of the substrate is preferably within the range of from 1.49 to 1.67.

As factors which are most important for the strength of the laminated structure of the present invention, there can be mentioned the interfacial interactions between the transparent thermoplastic resin substrate and the porous silica layer, and the strength of the transparent thermoplastic resin substrate per se. Therefore, it is preferred to use a transparent thermoplastic resin substrate which has a polar group. Examples of polar groups include a hydroxyl group, a silanol group, a siloxane group, an ether group, an ester group, a carbonyl group, a carboxyl group, a carbonate group, an amide group, a urea group, a urethane group and a sulfonyl group. By using a transparent thermoplastic resin substrate which has a polar group, an antireflection laminated structure having an improved mechanical strength can be obtained.

Further, it is preferred that the transparent thermoplastic resin substrate has a pencil hardness of from 1H to 8H, more advantageously from 1H to 7H. The term “pencil hardness” means a pencil hardness as measured in accordance with JIS K5400 under a load of 1 kg, using a testing pencil as defined in JIS S6006.

When the pencil hardness of the transparent thermoplastic resin substrate is less than 1H, there is a possibility that the pencil hardness of the laminated structure becomes unsatisfactory. On the other hand, when the pencil hardness of the transparent thermoplastic resin substrate is more than 8H, there is a possibility that the transparent thermoplastic resin substrate cannot exhibit a satisfactory effect of alleviating the stress sustained by the porous silica layer and the like (which are laminated on the substrate), so that the pencil hardness of the porous silica layer and the like becomes unsatisfactory.

In the present invention, the transparent thermoplastic resin substrate may be composed of a single-layer made of a single material. Alternatively, if desired, the transparent thermoplastic resin substrate may comprise a laminated structure which is obtained by laminating a plurality of layers of different materials. Specifically, for example, when a transparent thermoplastic resin substrate comprised of a single-layer made of a single material does not exhibit the desired properties (i.e., a refractive index of from 1.49 to 1.67, a pencil hardness of from 1H to 8H and the like), a transparent thermoplastic resin substrate comprised of a plurality of layers of different resins may be employed so as to achieve the desired properties.

More specifically, when a transparent thermoplastic resin substrate does not have a pencil hardness within the range of from 1H to 8H, or does not have a refractive index within the range of from 1.49 to 1.67, or does not have any of the above-exemplified polar groups, a hard coat layer may be formed thereon to obtain a transparent thermoplastic resin substrate having a hard coat layer formed thereon. Herein, the term “hard coat layer” means a layer which is formed on a surface of a transparent thermoplastic resin substrate for the purpose of reinforcing the substrate.

It is preferred to use a transparent thermoplastic resin substrate having a hard coat layer formed thereon especially when the strength of the surface of the transparent thermoplastic resin substrate is unsatisfactory.

A hard coat layer is formed by coating, on a transparent thermoplastic resin substrate, a curable, hard coat layer-forming material (e.g., an organic material, an organic/inorganic hybrid material or an inorganic material), and curing the resultant coating formed on the substrate. It is preferred that the curable, hard coat layer-forming material can be cured by heating, ultraviolet irradiation or electron beam irradiation.

Representative examples of preferred hard coat layer-forming materials include a melamine material, an acrylic material, an acrylic silicone material, a silicone material and an epoxy material. Further, for the purpose of improving various properties of a hard coat layer (e.g., improving the strength, adjusting the refractivity and imparting antistatistic property), the above-mentioned hard coat layer-forming material, as a matrix, may have organic and/or inorganic particles dispersed therein (hereinafter, such a hard coat layer-forming material having organic and/or inorganic particles dispersed therein is referred to as “organic/inorganic particles dispersion-type hard coat layer-forming material”).

Among the above-mentioned hard coat layer-forming materials, it is preferred to use an acrylic material comprising a multifunctional (meth)acrylate oligomer and/or a multifunctional (meth)acrylate monomer. Specific examples of multifunctional (meth)acrylate monomers include alkylene bis(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate and bis(trimethylol)propane tetra(meth)acrylate. The term “(meth)acrylate” means both an acrylate and a methacrylate.

Examples of multifunctional (meth)acrylate oligomers include an epoxy (meth)acrylate which is obtained by modifying a novolac-type or bisphenol-type epoxy resin with a (meth)acrylate; a urethane (meth)acrylate which is obtained by a process comprising reacting a polyisocyanate with a polyol to obtain a urethane compound and modifying the obtained urethane compound with a (meth)acrylate; and a polyester (meth)acrylate which is obtained by modifying a polyester resin with a (meth)acrylate.

As an acrylic silicone material for forming a hard coat layer, it is preferred to use a silicone resin which has (meth)acryl groups bonded thereto through covalent bonds.

As a silicone material for forming a hard coat layer, it is preferred to use a material which comprises a condensation product having a silanol group, wherein the condensation product is obtained by subjecting a conventional hydrolyzable group-containing silane to hydrolysis-polycondensation. In the case of this silicone material which comprises a condensation product having a silanol group, the silanol groups are converted into siloxane linkages by heat curing or the like after the coating of the material on a substrate, thereby obtaining a cured film (i.e., a hard coat layer).

As an epoxy material for forming a hard coat layer, it is preferred to use materials comprising an epoxy group-containing monomer, such as a bisphenol epoxy resin, trimethylolpropane triglycidyl ether, pentaerythritol triglycidyl ether and pentaerythritol tetraglycidyl ether.

Among the above-mentioned hard coat layer-forming materials, those which have a polar group are preferred. Examples of polar groups include a hydroxyl group, a silanol group, a siloxane group, an ether group, an ester group, a carbonyl group, a carboxyl group, a carbonate group, an amide group, a urea group, a urethane group and a sulfonyl group. By using a hard coat layer-forming material which has a polar group, a laminated structure having an improved mechanical strength can be obtained.

Specific examples of inorganic particles used in the above-mentioned organic/inorganic particles dispersion-type hard coat layer-forming material include silicon dioxide particles, titanium dioxide particles, aluminum oxide particles, zirconium oxide particles, tin oxide particles, calcium carbonate particles, barium sulfate particles, talc particles, kaolin particles and calcium sulfate particles. Specific examples of organic particles used in the above-mentioned organic/inorganic particles dispersion-type hard coat layer-forming material include methacrylic acid/methylacrylate copolymer particles, silicone resin particles, polystyrene particles, polycarbonate particles, acrylic acid/styrene copolymer particles, benzoguanamine resin particles, melamine resin particles, polyolefin particles, polyester particles, polyamide particles, polyimide particles and polyethylene fluoride particles. By using a hard coat layer-forming material containing these particles dispersed therein, the hardness of the hard coat layer can be improved, and curing shrinkage of the hard coat layer can be suppressed.

It is preferred that the above-mentioned inorganic particles and organic particles have an average particle diameter of from 0.01 to 2 μm, more advantageously from 0.02 to 0.5 μm. When the average particle diameter of the particles is less than 0.01 μm, there is a possibility that the advantageous effects of the particles cannot be satisfactorily exhibited. On the other hand, when the average particle diameter of the particles is more than 2 μm, the transparency of the laminated structure is lowered. The above-mentioned organic particles and inorganic particles may be used in any combinations, including combinations of organic particles and inorganic particles.

In the present invention, the above-mentioned organic particles and inorganic particles may be or may not be chemically bonded to the hard coat layer-forming material used as a matrix.

Specific examples of inorganic particles dispersion-type hard coat layer-forming materials include an acrylic material having inorganic particles dispersed threrein, an organic polymeric material having inorganic particles dispersed therein, an acrylic silicone material having inorganic particles dispersed therein, a silicone material having inorganic particles dispersed therein and an epoxy material having inorganic particles dispersed therein. It is especially preferred to use an acrylic material which has dispersed therein silica particles, titanium oxide particles, alumina particles or the like. Further, it is also preferred to use inorganic particles which have been surface-modified with a (meth)acryloyl group. The hard coat layer-forming material may contain various additives, such as a coloring agent (e.g., a pigment or a dye), an anti-foaming agent, a thickening agent, a leveling agent, a flame retardant, an ultraviolet absorber, an antistatic agent, an antioxidant and a modifier resin.

In the present invention, if desired, a solvent or the like may be added to the above-mentioned hard coat layer-forming material to thereby obtain a coating solution for forming a hard coat layer. The above-mentioned coating solution is coated on a transparent thermoplastic substrate, and the resultant coating on the substrate is cured, thereby forming a hard coat layer. Examples of solvents for the hard coat layer-forming material include water; alcohols, such as methanol, ethanol, 2-propanol, butanol and benzyl alcohol; ketones, such as acetone, methyl ethyl ketone, methyl isobutyl ketone and cyclohexanone; esters, such as methyl acetate, ethyl acetate, propyl acetate, butyl acetate, methyl formate, ethyl formate, propyl formate, butyl formate and γ-butyrolactone; aliphatic hydrocarbons, such as hexane and cyclohexane; halogenated hydrocarbons, such as methylene chloride and chloroform; aromatic hydrocarbons, such as benzene, toluene and xylene; amides, such as dimethylformamide, dimethylacetamide, N-methylpyrrolidone and N,N′-dimethyl imidazolidinone; ethers, such as diethyl ether, dioxane, tetrahydrofuran, ethylene glycol dimethyl ether, propylene glycol dimethyl ether and ethylene glycol diethyl ether; and alkanol ethers, such as ethylene glycol monomethyl ether, ethylene glycol monoethyl ether, propylene glycol monomethyl ether and propylene glycol monoethyl ether. Among these solvents, toluene, xylene, methyl ethyl ketone, methyl isobutyl ketone, cyclohexanone and butanol are preferred.

The above-mentioned hard coat layer-forming material may further contain a polymerization initiator, an additive, a solvent other than those mentioned above, a reactive diluent or the like, depending on the curing method thereof. As a polymerization initiator, any of conventional polymerization initiators (e.g., a heat type radical generator, a photo type radical generator, a heat type acid generator, a photo type acid generator, a heat type alkali generator and a photo type alkali generator) may be appropriately selected, depending on the type of reaction of the polymerizable functional group of the hard coat layer-forming material.

With respect to the coating method of the hard coat layer-forming material, there is no particular limitation, and the hard coat layer-forming material may be coated on a transparent thermoplastic resin substrate by any conventional coating method, such as a dip coating method, a spin coating method, a knife coating method, a bar coating method, a blade coating method, a squeeze coating method, a reverse-roll coating method, a gravure-roll coating method, a slide coating method, a curtain coating method, a spray coating method or a dye coating method. Among these coating methods, when the transparent thermoplastic resin substrate is in the form of a film, it is preferred to use coating methods which can be used to perform a continuous coating, such as a knife coating method, a bar coating method, a blade coating method, a squeeze coating method, a reverse-roll coating method, a gravure-roll coating method, a slide coating method, a curtain coating method, a spray coating method and a dye coating method.

After coating the hard coat layer-forming material on a transparent thermoplastic resin substrate, the resultant coating is cured by heating at a temperature of from 80 to 150° C. or by photoirradiation or by electron beam irradiation, thereby forming a hard coat layer on the substrate. The above-mentioned curing methods can be used individually or in combination.

It is preferred that the water contact angle of the hard coat layer on the surface thereof is within a specific range. Specifically, the water contact angle of the hard coat layer is preferably 85° or less, more preferably 80° or less, still more preferably 75° or less. When the water contact angle is more than 85, there is a possibility that cissings are formed when a porous silica layer is formed on the hard coat layer, and that the strength of the antireflection film becomes unsatisfactory. Therefore, when the hard coat layer has a water contact angle of 85° or more, it is preferred that the formulation of the hard coat layer-forming material is appropriately adjusted so as to control the water contact angle of the hard coat layer to the range of 85° or less, or that the hard coat layer is subjected to surface modification treatment, to appropriately reduce the water contact angle. Preferred examples of methods of surface modification treatment for reducing the water contact angle include irradiation of ultraviolet rays having a wavelength of less than 200 nm (e.g., deep-UV irradiation and excimer lamp irradiation), plasma treatment, electron beam irradiation, and treatment using a prime coat containing a silane coupling agent or the like.

It is preferred that the hard coat layer has a thickness of from 1 to 15 μm. When the hard coat layer has a thickness of less than 1 μm, there is a possibility that the hard coat layer does not exhibit satisfactory effects. On the other hand, when the hard coat layer has a thickness of more than 15 μm, there is a possibility that cracks are formed on the surface of the hard coat layer, and the laminated structure becomes warped.

With respect to the strength of the hard coat layer, it is preferred that the hard coat layer has a pencil hardness of from 1H to 8H, more advantageously from 2H to 8H, still more advantageously from 3H to 8H, as measured in accordance with JIS K5400.

It is preferred that the hard coat layer has a refractive index within the range of from 1.49 to 1.67. When the hard coat layer has a refractive index of less than 1.49, there is a possibility that the reflectance of the laminated structure cannot be satisfactorily reduced. On the other hand, when the hard coat layer has a refractive index of more than 1.67, there is a possibility that the reflectance of the laminated structure becomes disadvantageously large depending on the wavelength of visible light rays, resulting in that the laminated structure exhibits discoloration and/or glare.

In the present invention, as a hard coat layer-forming material, any of those which are commercially available can be used. Specific examples of commercially available hard coat layer-forming materials which can be preferably used include UV curable silicone hard coat X-12 series (manufactured and sold by Shin-Etsu Chemical Co., Ltd., Japan), UV curable silicone hard coat UVHC series and heat curable silicone hard coat SHC series (manufactured and sold by GE Toshiba Silicones Co., Ltd., Japan), heat curable silicone hard coat SolGard™ NP series (manufactured and sold by Nippon Dacro Shamrock Co., Ltd., Japan) and UV curable hard coat KAYANOVA FOP series (manufactured and sold by Nippon Kayaku Co., Ltd., Japan).

With respect to the silica-containing laminated structure of the present invention, the at least one porous silica layer is comprised of a plurality of moniliform silica strings, each comprising a plurality of primary silica particles which are linked in rosary form, and the pores of the at least one porous silica layer include pores (P), each of the pores (P) having a pore opening area which is larger than the average value of the respective maximum cross-sectional areas of the primary silica particles (wherein the pore opening areas of the pores (P) are measured with respect to the pore openings in the surface or cross-section of the porous silica layer).

Herein, the term “primary silica particles” means separate, non-linked silica particles which constitute each of moniliform silica strings.

The term “moniliform silica string” means a string of silica in which the above-mentioned primary silica particles are linked in rosary form by chemical bonds (e.g., siloxane linkages). A moniliform silica string may be in a straight form, or may be curved two-dimensionally or three-dimensionally. Further, a moniliform silica string may be linear or branched.

Each of the above-mentioned moniliform silica strings comprises 2 or more primary silica particles having an average particle diameter of from 1 to 30 nm, preferably from 3 to 25 nm, and the number of the primary silica particles present in each moniliform silica string is such that the moniliform silica strings have an average length of from 20 to 250 nm, preferably from 30 to 200 nm.

The term “average particle diameter” is a value obtained by the following formula:

average particle diameter (unit: nm)=(2,720/specific surface area), wherein the specific surface area (m²/g) is measured by a conventional nitrogen adsorption method (BET method) (see Unexamined Japanese Patent Application Laid-Open Specification No. Hei 1-317115). The term “average length” is a value as measured by the dynamic light scattering method. The average length can be measured by, for example, a dynamic light scattering method described in “Journal of Chemical Physics”, Vol. 57, No.11, p. 4,814 (1972).

When the average particle diameter of the primary silica particles constituting the moniliform silica strings is less than 1 nm, there is a tendency that the volume of each of the voids (pores) formed between mutually adjacent silica strings in the porous silica layer becomes small, so that the total volume of all pores present in the porous silica layer becomes disadvantageously small, thus rendering it difficult to lower the refractivity of the porous silica layer. On the other hand, when the average particle diameter of the primary silica particles constituting the moniliform silica strings is more than 30 nm, there is a possibility that the arithmetic mean surface roughness (Ra) of the porous silica layer becomes more than 50 nm, so that haze tends to occur and the resolution of an image which is observed through the silica-containing laminated structure tends to be lowered, thus lowering the visibility of the image.

Further, when the average length of the moniliform silica strings is less than 20 nm, there is also a tendency that the volume of each of voids (pores) formed between mutually adjacent silica strings in the porous silica layer becomes small, so that the total volume of all pores present in the porous silica layer becomes disadvantageously small, thus rendering it difficult to lower the refractivity of the porous silica layer. On the other hand, when the average length of the moniliform silica strings is more than 250 nm, there is also a possibility that the arithmetic mean surface roughness (Ra) of the porous silica layer becomes more than 50 nm, so that haze tends to occur and the resolution of an image which is observed through the silica-containing laminated structure tends to be lowered, thus lowering the visibility of the image.

The average length of the moniliform silica strings is preferably from 30 to 200 nm. When the moniliform silica strings have an average length of less than 30 nm, there is a tendency that the strength of the moniliform silica strings per se becomes unsatisfactory, and that the number of points at which moniliform silica strings are in contact and linked with each other becomes small. Therefore, when the moniliform silica strings have an average length of less than 30 nm, a problem is likely to be posed in that for forming a porous silica layer having satisfactory strength, it is necessary to perform heating at a temperature higher than 150° C. However, by heating at such a high temperature (i.e., higher than 150° C.), the resultant porous silica layer exhibits shrinkage, thus causing a marked decrease in the volume of pores which are present in the porous silica layer, leading to disadvantages not only in that a porous silica layer having a satisfactorily low refractive index cannot be obtained, but also in that cracking occurs in the porous silica layer. Further, when a transparent thermoplastic resin substrate is exposed to such a high temperature (i.e., higher than 150° C.), the transparent thermoplastic resin substrate is likely to suffer heat distortion. Thus, heating at such a high temperature is not practical in the present invention, which uses a transparent thermoplastic resin substrate. On the other hand, when the moniliform silica strings have an average length of more than 200 nm, a disadvantage may be caused in that the surface of the porous silica layer becomes markedly uneven, so that the moniliform silica strings (which are present at a portion near the surface) come off upon abrasion.

Specific examples of moniliform silica strings include Snowtex™ OUP (average length: 40 to 100 nm), Snowtex™ UP (average length: 40 to 100 nm), Snowtex™ PS-M (average length: 80 to 150 nm), Snowtex™ PS-MO (average length: 80 to 150 nm), Snowtex™ PS-S (average length: 80 to 120 nm), Snowtex™ PS-SO (average length: 80 to 120 nm), IPA-ST-UP (average length: 40 to 100 nm) (each manufactured and sold by Nissan Chemical Industries, Ltd., Japan), and Fine Cataloid F-120 (manufactured and sold by Catalysts & Chemicals Industries, Ltd., Japan). These moniliform silica strings have a dense skeleton of silica, and have a three-dimensionally curved form.

In the present invention, by virtue of the presence of moniliform silica strings in the porous silica layer, voids (pores) are formed between mutually adjacent silica strings in the porous silica layer, thereby lowering the refractivity of the porous silica layer. The pores of the porous silica layer include pores (P), each of the pores (P) having a pore opening area which is larger than the average value of the respective maximum cross-sectional areas of the primary silica particles (wherein the pore opening areas of the pores (P) are measured with respect to the pore openings in the surface or cross-section of the porous silica layer). Therefore, the total volume of all pores present in a porous silica layer containing moniliform silica strings becomes larger than that in the case of a porous silica layer comprising only separate, non-linked primary silica particles, thereby enabling production of a porous silica layer having a refractive index as low as from 1.22 or more to less than 1.30. Especially when a transparent thermoplastic resin substrate having a refractive index of from 1.49 to 1.67 is used, there can be obtained a silica-containing laminated structure having very low reflectance.

The presence of pores (P) each having a pore opening area which is larger than the average value of the respective maximum cross-sectional areas of the primary silica particles, can be confirmed as follows.

A surface or cross-section of the porous silica layer is coated with an electroconductive material (e.g., gold, platinum, an alloy of gold and palladium, an alloy of platinum and palladium, osmium, chrome and carbon) so as to form an electroconductive coating having a thickness of from 1 to 3 nm on the surface or cross-section of the porous silica layer. Then, using a scanning electron microscope, the surface or cross-section having the eletroconductive coating formed thereon is observed at an acceleration voltage of from 0.5 to 3.0 kV to thereby obtain a photomicrograph in which the contrast between moniliform silica strings and pores is fairly clear. When taking a photomicrograph, it is required to adjust the acceleration voltage of the scanning electron microscope or to adjust the brightness or contrast of the photomicrograph so that the photomicrograph does not exhibit a luminance distribution wherein a substantial area of the photomicrograph has a luminance of 0% or 100%. The luminance distribution of the obtained photomicrograph is calculated, and the portions of the photomicrograph where the luminance is not more than the value represented by the formula: L+(PB−L)/3 (wherein PB represents the peak luminance and L represents the minimum luminance), are defined as pores.

Subsequently, in the obtained photomicrograph, images of primary silica particles which constitute moniliform silica strings and which are substantially circular are selected. Herein, a “substantially circular image” means an image in which a value represented by the formula: 4π×(area)/(length of circumference)² is close to 1, wherein when the above-mentioned value is 1, the image is a true circle. Specifically, the above-mentioned substantially circular image is, for example, an image having a roundness parameter of 110 or more as measured by an image analysis software “Azokun™” (manufactured and sold by Asahi Kasei Kabushiki Kaisha, Japan). Then, the distribution of the areas of the selected images in the photomicrograph is calculated, and the average value of the areas of the selected images (i.e., average value of the respective maximum cross-sectional areas of the primary silica particles) is designated as (a₂), and the standard deviation of the areas of the selected images (i.e., standard deviation of the measured values of the respective maximum cross-sectional areas of the primary silica particles) is designated as σ.

After the above-mentioned substantially circular images are selected, the photomicrograph is subjected to mapping with respect to the images of pores therein, to thereby count the number of pores and calculate the pore opening area of each of the pores. The total of pore opening areas of all pores in the photomicrograph is designated as (S), the total of pore opening areas of pores (P) each having a pore opening area larger than (a₂) is designated as (Sₐ₂), the total of pore opening areas of pores each having a pore opening area larger than (a₂+σ) is designated as (S_{(a2+σ)}), the total of pore opening areas of pores each having a pore opening area larger than (a₂+2σ) is designated as (S_{(a2+2σ)}), and the total of pore opening areas of pores each having a pore opening area larger than (a₂+3σ) is designated as (S_{(a2+3σ)}). In the present invention, with respect to the porous silica layer, it is preferred that (Sₐ₂) and (S) as described above satisfy the formula: (Sₐ₂)/(S)≧0.5; it is more preferred that (S_{(a2+σ)}) and (S) as described above satisfy the formula: (S_{(a2+σ)})/(S)≧0.5; it is still more preferred that (S_{(a2+2σ)}) as described above satisfies the formula (S_{(a2+2σ)})≧0.5; and it is still more preferred that (S_{(a2+3σ)}) as described above satisfies the formula: (S_{(a2+3σ)})≧0.5. When (Sₐ₂)/(S) is less than 0.5, there is a possibility that the refractive index of the porous silica layer becomes disadvantageously as high as 1.30 or more, thus rendering unsatisfactory the antireflection effect of the porous silica layer.

The porous silica layer has a substantially uniform porous structure. Therefore, substantially the same results can be obtained from the above-mentioned measurement (i.e., confirmation of the presence of pores (P) defined in the present invention) irrespective of whether the above-mentioned measurement is performed with respect to a surface of the porous silica layer or with respect to a cross-section of the porous silica layer.

In the present invention, the porous silica layer exhibits not only low refractivity but also high strength, by virtue of containing moniliform silica strings. The reason for this is that the number of points at which moniliform silica strings are in contact and linked with each other is large, as compared to the number of the contact/linking points in the case of the use of separate, non-linked silica particles. Therefore, an antireflection film having high strength can be obtained using a porous silica comprising moniliform silica strings.

In the present invention, the porous silica layer may comprise only moniliform silica strings. However, for the purpose of, e.g., adjusting the refractivity and controlling the surface unevenness, the porous silica layer may further comprise any silica other than moniliform silica strings. Specific examples of silica other than moniliform silica strings include spherical silica and non-spherical silica, such as a scale form of silica.

When the porous silica layer contains any silica other than moniliform silica strings, it is preferred that the amount of silicon atoms present in the moniliform silica strings is 15.0% or more, more advantageously from 15.0 to 99.9%, still more advantageously from 25.0% to 99.5%, still more advantageously from 30.0 to 99.0%, based on the total number of silicon atoms present in the porous silica layer. When the amount of silicon atoms present in the moniliform silica strings is less than 15.0%, based on the total number of silicon atoms present in the porous silica layer, there is a possibility that it becomes difficult to satisfactorily reduce the refractivity of the porous silica layer.

In the present invention, the porous silica layer has a refractive index of 1.22 or more and less than 1.30, preferably from 1.22 or more to less than 1.28. When the refractivity of the porous silica layer is as high as 1.30 or more, the reflectance of the porous silica layer cannot be satisfactorily reduced. On the other hand, when the refractivity of the porous silica layer is less than 1.22, problems are posed not only in that the reflectance of the porous silica layer cannot be satisfactorily reduced, but also in that the density of the porous silica layer becomes too low, resulting in that the mechanical strength of the porous silica layer becomes unsatisfactory.

With respect to the thickness of the porous silica layer, there is no particular limitation. For example, when a single layer of porous silica layer is formed on a substrate, the thickness of the porous silica layer is generally in the range of from 50 to 1,000 nm, preferably from 50 to 500 nm, more preferably from 60 to 200 nm. In either the case where the thickness of the porous silica layer is less than 50 nm or the case where the thickness of the porous silica layer is more than 1,000 nm, there is a possibility that the antireflection effect of the porous silica layer becomes lowered.

The silica contained in the porous silica layer (i.e., moniliform silica strings and silica (if any) other than moniliform silica strings) is adhered to and crosslinked with each other, thereby forming a film having high strength. However, for further improving the strength of such adhesion and crosslinking, it is preferred that silica used for forming the porous silica layer is preliminarily modified with a hydrolyzable group-containing silane. With respect to the amount of the above-mentioned hydrolyzable group-containing silane, it is preferred that the molar ratio of the hydrolyzable group-containing silane to the silicon atoms present in the silica is from 0.005 to 1.0. Examples of hydrolyzable group-containing silanes are as described below.

Further, it is preferred that the porous silica layer contains an alkaline earth metal salt, because the strength of the silica-containing laminated structure can be improved. With respect to the amount of the alkaline earth metal salt, it is preferred that the molar ratio of the alkaline earth metal salt to the silicon atoms present in the silica is from 0.001 to 0.1. Examples of alkaline earth metal salts are as described below.

Further, for the purpose of, e.g., smoothing the silica-containing laminated structure and imparting stainproofing property to the silica-containing laminated structure, an optional layer having a thickness of from 0.1 to 100 nm may be laminated on the laminated structure, as long as the effects of the present invention are not impaired. Examples of optional layers include a stainproofing layer and a water repellent layer. For example, a fluoropolymer layer as an optional layer exhibits stainproof property and water repellency.

Next, an explanation is given with respect to a coating composition which can be advantageously used for forming the porous silica layer contained in the silica-containing laminated structure of the present invention.

Accordingly, in another aspect of the present invention, there is provided a coating composition for use in forming on a substrate a porous silica layer having a low refractivity, which comprises a product obtained by a method comprising:

mixing a dispersion of moniliform silica strings with a hydrolyzable group-containing silane to obtain a mixture, wherein each of the moniliform silica strings comprises a plurality of primary silica particles which are linked in rosary form, and

subjecting the obtained mixture to hydrolysis and dehydration-condensation.

The type of moniliform silica strings employed is as described above in connection with the silica-containing laminated structure of the present invention. With respect to the silica contained in the coating composition, the coating composition may contain only moniliform silica strings, or may contain moniliform silica strings and any silica other than moniliform silica strings. Specific examples of silica other than moniliform silica strings include spherical silica and non-spherical silica, such as a scale form of silica.

When the coating composition of the present invention contains silica other than moniliform silica strings, it is preferred that the percentage of the number of silicon atoms constituting the moniliform silica strings is 15.0% or more, more advantageously from 15.0 to 99.9%, still more advantageously from 25.0% to 99.5%, still more advantageously from 30.0 to 99.0%, based on the number of all silicon atoms present in the coating composition. When the percentage of the number of silicon atoms constituting the moniliform silica strings is less than 15.0%, there is a possibility that the refractivity of the porous silica layer formed cannot be satisfactorily reduced.

From the viewpoint of improving the film-forming ability, it is preferred that the silica content (the total silica content covering both of moniliform silica strings and silica (if any) other than moniliform silica strings which is optionally used) of the coating composition is from 0.01 to 10% by weight, more advantageously from 0.05 to 5% by weight. When the silica content of the coating composition is less than 0.01% by weight, it becomes difficult to control the film thickness. On the other and, when the silica content is more than 10% by weight, the viscosity of the coating composition becomes disadvantageously high, resulting in that the coatability and film-forming ability of the coating composition tend to become lowered.

When the coating composition of the present invention is coated on a substrate, followed by drying and curing, the silica contained in the coating composition (i.e., moniliform silica strings and silica (if any) other than moniliform silica strings) becomes adhered to and crosslinked with each other, thereby forming a film having high strength. However, for further improving the strength of such adhesion and crosslinking, it is preferred that the coating composition contains a hydrolyzable group-containing silane.

The hydrolyzable group of the above-mentioned hydrolyzable group-containing silane may be any group (or atom) which can form a hydroxyl group by a hydrolysis reaction. Examples of hydrolyzable groups include a halogen atom, an alkoxy group, an acyloxy group, an amino group, an enoxy group and an oxime group.

Examples of hydrolyzable group-containing silanes include silanes which are represented by formula (2) below and silanes which are represented by formula (3) below:
R¹ₙSiX₄₋ₙ (2)
wherein R¹ represents a hydrogen atom, a C₁-C₁₀ alkyl group, a C₁-C₁₀ alkenyl group, C₁-C₁₀ alkenyl group or a C₁-C₁₀ aryl group, X represents a hydrolyzable group, and n is an integer of from 0 to 3, wherein when R¹ is not a hydrogen atom, R¹ may be unsubstituted or substituted with a functional group, such as a halogen atom, a hydroxy group, a mercapto group, an amino group, a (meth)acryloyl group or an epoxy group; and
   X₃Si—R²ₙ—SiX₃ (3)
wherein X represents a hydolyzable group, R² represents a C₁-C₆ alkylene group or a phenylene group, and n is 0 or 1.

Specific examples of hydrolyzable group-containing silanes include tetramethoxysilane, tetraethoxysilane, tetra(n-propoxy)silane, tetra(i-propoxy)silane, tetra(n-butoxy)silane, tetra(i-butoxy)silane, tetra-sec-butoxysilane, tetra-tert-butoxysilane, trimethoxysilane, triethoxysilane, methyltrimethoxysilane, methyltriethoxysilane, ethyltrimethoxysilane, ethyltriethoxysilane, propyltrimethoxysilane, propyltriethoxysilane, isobutyltriethoxysilane, cyclohexyltrimethoxysilane, phenyltrimethoxysilane, phenyltriethoxysilane, dimethoxysilane, diethoxysilane, methyldimethoxysilane, methyldiethoxysilane, dimethyldimethoxysilane, dimethyldiethoxysilane, bis(trimethoxysilyl)methane, bis(triethoxysilyl)methane, bis(triphenoxysilyl)methane, bis(trimethoxysilyl)ethane, bis(triethoxysilyl)ethane, bis(triphenoxysilyl)ethane, 1,3-bis(trimethoxysilyl)propane, 1,3-bis(triethoxysilyl)propane, 1,3-bis(triphenoxysilyl)propane, 1,4-bis(trimethoxysilyl)benzene, 1,4-bis(triethoxysilyl)benzene, 3-chloropropyltrimethoxysilane, 3-chloropropyltriethoxysilane, 3-hydroxypropyltrimethoxysilane, 3-hydroxypropyltriethoxysilane, 3-mercaptopropyltrimethoxysilane, 3-mercaptopropyltriethoxysilane, 3-glycidoxypropyltrimethoxysilane, 3-glycidoxypropyltriethoxysilane, 3-acryloxypropyltrimethoxysilane, 3-acryloxypropyltriethoxysilane, 3-methacryloxypropyltrimethoxysilane, 3-methacryloxypropyltriethoxysilane, tetraacetoxysilane, tetrakis(trichloroacetoxy)silane, tetrakis(trifluoroacetoxy)silane, triacetoxysilane, tris(trichloroacetoxy)silane, tris(trifluoroacetoxy)silane, methyltriacetoxysilane, methyltris(trichloroacetoxy)silane, tetrachlorosilane, tetrabromosilane, tetrafluorosilane, trichlorosilane, tribromosilane, trifluorosilane, methyltrichlorosilane, methyltribromosilane, methyltrifluorosilane, tetrakis(methylethylketoxime)silane, tris(methylethylketoxime)silane, methyltris(methylethylketoxime)silane, phenyltris(methylethylketoxime)silane, bis(methylethylketoxime)silane, methylbis(methylethylketoxime)silane, hexamethyldisilazane, hexamethylcyclotrisilazane, bis(dimethylamino)dimethylsilane, bis(diethylamino)diemthylsilane, bis(dimethylamino)methylsilane and bis (diethylamino)methylsilane.

Further examples of hydrolyzable group-containing silanes include those which are represented by formula (4) below, such as methyl silicate 51, ethyl silicate 40 and ethyl silicate 48 (each of which are manufactured and sold by COLCOAT Co., Ltd., Japan):
R³—(O—Si(OR³)₂)ₙ—OR³ (4)
wherein R³ represents a C₁-C₆ alkyl group, and
n is an integer of from 2 to 8.

The above-mentioned hydrolyzable group-containing silanes may be used individually or in combination.

Among the above-mentioned hydrolyzable group-containing silanes, tetramethoxysilane and tetraethoxysilane are preferred.

With respect to the above-mentioned hydrolyzable group-containing silanes, a part or all of the hydrolyzable groups may be converted into silanol groups by the hydrolysis reaction performed in the production of the coating composition. Therefore, a part or all of the hydrolyzable group-containing silanes may be replaced by silanol group-containing silanes. Examples of silanol group-containing silanes include silanes, such as silicic acid, trimethylsilanol, triphenylsilanol, dimethylsilanediol and diphenylsilanediol; polysiloxanes which have terminal or pendant hydroxyl groups; silicates, such as sodium orthosilicate, potassium orthosilicate, lithium orthosilicate, sodium metasilicate, potassium metasilicate, lithium metasilicate, tetramethylammonium orthosilicate, tetrapropylammonium orthosilicate, tetramethylammonium metasilicate and tetrapropylammonium metasilicate; and activated silica, which can be obtained by contacting any of the above-mentioned silicates with an acid or an ion exchange resin.

With respect to the amount of the above-mentioned hydrolyzable group-containing silane, it is preferred that the molar ratio of the hydrolyzable group-containing silane to all silicon atoms present in the moniliform silica strings is from 0.005 to 1.0, more advantageously from 0.01 to 0.5. When the above-mentioned molar ratio is less than 0.005, the advantageous effect of the hydrolyzable group-containing silane cannot be satisfactorily exhibited. On the other hand, when the above-mentioned molar ratio is more than 1.0, there is a possibility that condensation products of the hydrolyzable group-containing silane fill the voids (pores) between the silica particles, so that the refractive index of the laminated structure becomes disadvantageously high, as high as 1.30 or more.

The coating composition of the present invention for use in forming a porous silica layer having a low refractivity is obtained by dispersing, in a dispersion medium, moniliform silica strings and, optionally, silica other than moniliform silica strings, and dissolving a hydrolyzable group-containing silane in the dispersion medium. With respect to the dispersion medium, there is no particular limitation as long as the silica particles can be substantially stably dispersed therein, and the hydrolyzable group-containing silane and the below-mentioned additives can be dissolved therein.

Specific examples of dispersion mediums include water; alcohols, such as monohydric C₁-C₆ alcohols, dihydric C₁-C₆ alcohols and glycerol; amides, such as formamide, N-methylformamide, N-ethylformamide, N,N-dimethylformamide, N,N-diethylformamide, N-methylacetamide, N-ethylacetamide, N,N-dimethylacetamide, N,N-diethylacetamide and N-methylpyrrolidone; ethers, such as tetrahydrofuran, diethyl ether, di(n-propyl) ether, diisopropyl ether, diglyme, 1,4-dioxane, ethylene glycol monomethyl ether, ethylene glycol dimethyl ether, ethylene glycol diethyl ether, propylene glycol monomethyl ether and propylene glycol dimethyl ether; esters, such as ethyl formate, methyl acetate, ethyl acetate, ethyl lactate, ethylene glycol monomethyl ether acetate, ethylene glycol diacetate, propylene glycol monomethyl ether acetate, diethyl carbonate, ethylene carbonate and propylene carbonate; ketones, such as acetone, methyl ethyl ketone, methyl propyl ketone, methyl (n-butyl) ketone, methyl isobutyl ketone, methyl amyl ketone, cyclopentanone and cyclohexanone; nitriles, such as acetonitrile, propionitrile, n-butyronitrile and isobutyronitrile; dimethyl sulfoxide; dimethyl sulfone; and sulfolane. These solvents may be used in combination, or in mixture with another appropriate solvent or an additive so long as the effects of the present invention are not impaired.

Preferred examples of dispersion mediums include monohydric C₁-C₆ alcohols and alkanol ethers, such as ethylene glycol monomethyl ether and propylene glycol monomethyl ether.

It is preferred that the coating composition of the present invention contains water. The water content of the coating composition is preferably more than 1.5 parts by weight, per part by weight of the moniliform silica strings. When the water content is 1.5 parts by weight or less, a satisfactory adhesion strength between the silica strings cannot be obtained by a heat treatment at a low temperature, so that a heat treatment at 300° C. or more becomes necessary for forming an antireflection film having a satisfactory strength for practical use, thus rendering it impossible to form an antireflection film on a thermoplastic resin substrate. With respect to the upper limit of the water content, there is no particular limitation; however, the water content is preferably 10,000 parts by weight or less, more preferably 2,000 parts by weight or less, per part by weight of the moniliform silica strings.

In the present invention, from the viewpoint of promoting the hydrolysis and dehydration-condensation of the hydrolyzable group-containing silane, it is preferred that the coating composition contains a catalyst. Examples of catalysts include acidic catalysts, basic catalysts and organotin compounds. Among these, acidic catalysts are especially preferred. Specific examples of acidic catalysts include mineral acids, such as nitric acid and hydrochloric acid; and organic acids, such as oxalic acid and acetic acid.

With respect to the amount of acid as a catalyst, it is preferred that the coating composition contains the acid in a concentration of 0.0008 mol/liter or more, more advantageously from 0.0008 to 1 mol/liter. When the acid concentration is less than 0.0008 mol/liter, there is a possibility that the step of hydrolysis and dehydration-condensation of the hydrolyzable group-containing silane does not satisfactorily proceed, so that an antireflection film having satisfactory strength cannot be obtained, and that the coating composition cannot be uniformly coated on a substrate depending on the type of substrate used. On the other hand, when the acid concentration is more than 1 mol/liter, there is a possibility that the stability of the coating composition becomes lowered.

It is preferred that the coating composition of the present invention contains an alkaline earth metal salt because the coating formability of the coating composition and the strength of the antireflection film can be improved. Preferred examples of alkaline earth metal salts include inorganic salts (e.g., chloride compounds, nitrates and sulfates) and organic salts (e.g., formates and acetates) of alkaline earth metals, such as magnesium, calcium, strontium and barium. Among these, inorganic salts and organic salts of magnesium and calcium are especially preferred.

The above-mentioned alkaline earth metal salts may be used individually or in combination.

With respect to the amount of the alkaline earth metal salt, it is preferred that the molar ratio of the alkaline earth metal salt to the silicon atoms present in the moniliform silica strings is from 0.001 to 0.1, more advantageously from 0.005 to 0.05.

In the present invention, if desired, various additives may be added to the coating composition as long as the effects of the present invention are not impaired. Examples of additives include a coloring agent, an anti-foaming agent, a thickening agent, a leveling agent, a flame retardant, an ultraviolet absorber, an antistatic agent, an antioxidant and a modifier resin. Further, when the above-mentioned hydrolyzable group-containing silane has a polymerizable functional group, any of a photo type radical generator, a heat type radical generator, a photo type acid generator, a heat type acid generator, a photo type alkali generator, a heat type alkali generator and a polymerization inhibitor may be added depending on the mode of polymerization reaction to be performed.

Next, an explanation is given with respect to the method for producing the coating composition of the present invention, and to the antireflection film of the present invention comprising a porous silica layer which is formed using the coating composition of the present invention.

In the present invention, moniliform silica strings and, optionally, silica other than moniliform silica strings and a hydrolyzable group-containing silane are dispersed/dissolved in the dispersion medium, whereupon, if desired, the resultant mixture is further mixed with a hydrolyzable group-containing silane and other additives, thereby obtaining the coating composition for use in forming a porous silica layer having low refractivity.

With respect to the mixing of the hydrolyzable group-containing silane, the hydrolyzable group-containing silane may be subjected to hydrolysis and dehydration-condensation prior to the mixing with the above-mentioned silica. However, from the viewpoint of obtaining an antireflection film having excellent mechanical strength, it is recommended that the step of subjecting the hydrolyzable group-containing silane represented by any one of formulae (2) to (4) to the hydrolysis and dehydration-condensation is performed in the presence of the above-mentioned silica. Specifically, the dispersion of moniliform silica strings is mixed with a hydrolyzable group-containing silane represented by any one of formulae (2) to (4) and, optionally, an additive (e.g., water and a catalyst), and the resultant mixture is subjected to hydrolysis and dehydration-condensation, thereby effecting hydrolysis and dehydration-condensation of the above-mentioned silica in the presence of the hydrolyzable group-containing silane.

With respect to the step of hydrolysis and dehydration-condensation, it is preferred that the reaction temperature is as high as possible, since the higher the reaction temperature, the higher the productivity. However, when the reaction rate becomes too high, the dehydration-condensation reaction is excessively promoted and, thus, the viscosity of the coating composition becomes too high, posing a problem in that the coating composition cannot be coated on a substrate. Therefore, the step of hydrolysis and dehydration-condensation is generally performed at a temperature at which the viscosity of the coating composition can be easily adjusted. Specifically, the step of hydrolysis and dehydration-condensation is generally performed at 20 to 100° C., more preferably 20 to 60° C., still more preferably 20 to 40° C. When the step of hydrolysis and dehydration-condensation is performed at a temperature within the above-mentioned range, the reaction time is, for example, at least 1 hour at 20° C. and at least 20 minutes at 60° C.

As mentioned above, it is preferred that the step of hydrolysis and dehydration-condensation is performed in the presence of a catalyst and water. The type of catalyst used and the amounts of catalyst and water are as described above in connection with the silica-containing laminated structure of the present invention.

In the present invention, it is presumed that, by virtue of the step of subjecting a hydrolyzable group-containing silane to hydrolysis and dehydration-condensation in the presence of moniliform silica strings and, optionally, silica other than moniliform silica strings, the coating composition obtained is advantageous not only in that the surfaces of the silica particles are modified with the hydrolyzable group-containing silane, thereby improving the strength of the silica particles, but also in that, during the coating of the coating composition, the moniliform silica strings are bonded to each other through the siloxane linkages of the silanol groups which are derived from the hydrolyzable group-containing silane, thereby improving the adhesion strength between the moniliform silica strings. Therefore, in the present invention (where a hydrolyzable group-containing silane is subjected to hydrolysis and dehydration-condensation in the presence of a silica comprising moniliform silica strings), it becomes possible to form a porous silica layer having high strength, as compared to the case where a hydrolyzable group-containing silane is subjected to hydrolysis and dehydration-condensation prior to mixing with a silica comprising moniliform silica strings.

Further, if desired, the above-mentioned alkaline earth metal salt and various additives may be added to the coating composition of the present invention. The alkaline earth metal salt and various additives may be added at any time before, during or after the step of hydrolysis and dehydration-condensation.

The thus obtained coating composition is applied to a substrate (e.g., the above-mentioned transparent thermoplastic resin substrate which may optionally have a hard coat layer formed thereon) to thereby form a coating on the substrate. The application of the coating composition to the substrate can be performed by any of conventional coating methods, such as a dip coating method, a spin coating method, a knife coating method, a bar coating method, a blade coating method, a squeeze coating method, a reverse-roll coating method, a gravure-roll coating method, a slide coating method, a curtain coating method, a spray coating method and a dye coating method. Among these coating methods, when the transparent thermoplastic resin substrate is in the form of a film, it is preferred to use coating methods which can be used to perform a continuous coating, such as a knife coating method, a bar coating method, a blade coating method, a squeeze coating method, a reverse-roll coating method, a gravure-roll coating method, a slide coating method, a curtain coating method, a spray coating method and a dye coating method.

The coating formed on the transparent thermoplastic resin substrate is then subjected to heat treatment at a temperature which is lower than the heat resistance temperature of the substrate, to thereby convert silanol groups into siloxane linkages, (the silanol groups existing on the surface of the silica or being generated when the hydrolyzable group-containing silane was subjected to hydrolysis,) thereby curing the coating formed on the substrate. The curing temperature of the coating can be changed depending on the heat resistance temperature of the transparent thermoplastic resin substrate; however, the curing temperature is generally from 60 to 150° C., preferably from 70 to 130° C., more preferably from 80 to 120° C. When the curing temperature is lower than 60° C., a porous silica layer which has satisfactory adhesion property cannot be obtained. On the other hand, when the curing temperature is higher than 150° C., the resultant porous silica layer exhibits shrinkage, thus causing a marked decrease in the volume of pores which are present in the porous silica layer, leading to disadvantages not only in that a porous silica layer having a satisfactorily low refractive index cannot be obtained, but also in that cracking occurs in the porous silica layer. Further, when a transparent thermoplastic resin substrate is exposed to such a high temperature (i.e., higher than 150° C.), the transparent thermoplastic resin substrate is likely to suffer heat distortion. Thus, a curing temperature higher than 150° C. is not practical in the present invention, which uses a transparent thermoplastic resin substrate.

The above-mentioned heat treatment can be performed by microwave irradiation.

The curing time is within 1 hour, preferably within 30 minutes, more preferably within 15 minutes.

When the hydrolyzable group-containing silane and/or additives contained in the coating formed on the substrate has polymerizable functional groups, if desired, the coating may be subjected to photo irradiation or electron beam irradiation.

Further, the antireflection film of the present invention can also be obtained by a method which comprises: providing a carrier film which was subjected to a treatment for improving the mold release property thereof; forming, on the carrier film, a multilayer transfer film comprising a porous silica layer (to be transferred) and an adhesive layer; and transferring the multilayer film onto a transparent thermoplastic resin substrate by utilizing the adhesive layer of the multilayer film. The multilayer film may further comprise any other functional layers, such as a hard coat layer and an antistatic layer.

Thus, a porous silica layer is formed by the above-explained procedure. As mentioned above, the film thickness of the porous silica layer is from 50 to 1,000 nm, preferably from 50 to 500 nm, more preferably from 60 to 200 nm.

The thus obtained silica-containing laminated structure (which comprises a substrate and, laminated thereon, a porous silica layer having low refractivity) as such can be advantageously used as an antireflection film. However, for the purpose of, e.g., smoothing the antireflection film and imparting stainproofing property to the antireflection film, an optional layer having a thickness of from 0.1 to 100 nm may be laminated on the laminated structure, as long as the effects of the present invention are not impaired. Examples of optional layers include a stainproofing layer and a water repellent layer. Specifically, for example, a fluoropolymer layer is stainproof and water repellent. Further, when only one of the outermost layers of the laminated structure is a porous silica layer, an adhesive layer may be laminated on the other outermost layer which is not a porous silica layer. As an adhesive layer, any conventional adhesives, such as a natural product-type adhesive, a thermoplastic resin adhesive, a thermosetting resin adhesive and an elastomer adhesive may be used. The thickness of the adhesive layer may be appropriately selected within the range of from 0.001 to 30 mm, depending on the use of the antireflection film.

The refractivity of the porous silica layer obtained from the coating composition of the present invention can be satisfactorily reduced by virtue of the moniliform silica strings contained therein. The reason for this is not clear, but is presumed to be as follows. By using moniliform silica strings, voids (pores) are formed between mutually adjacent silica strings in the porous silica layer. These pores have an extremely large volume, as compared to the volume of the pores produced in a porous silica layer which is formed from separate, non-linked primary silica particles. By virtue of these pores having an extremely large volume, the refractivity of the porous silica layer can be satisfactorily reduced.

It is preferred that a porous silica layer formed using the coating composition of the present invention has pores (P), each of which has a pore opening area which is larger than the average value of the respective maximum cross-sectional areas of the primary silica particles. The presence of pores (P) can be confirmed by the method explained above in connection with the silica-containing laminated structure of the present invention.

By using the coating composition of the present invention, it becomes possible to form a porous silica layer at a temperature which is lower than that employed in the prior art and, hence, it has become possible to form a porous silica layer on an optical film or the like which has poor heat resistance and which cannot be used in the prior art. Further, the porous silica layer which is formed using the coating composition of the present invention has excellent mechanical strength, so that the porous silica layer can be used as an optical part in a wide variety of application fields. For example, when a plastic lens for eye-glasses is used as the transparent thermoplastic resin substrate (on which the porous silica layer is formed), the porous silica layer formed on the plastic lens functions as an excellent antireflection film. Further, the porous silica layer (formed on a plastic lens for eye-glasses) may have, laminated thereon, an antifogging layer, an antistatic layer or the like, to thereby obtain a lens for eye-glasses which exhibits an excellent antireflection effect. Alternatively, the silica-containing laminated structure of the present invention may be used by a method in which the silica-containing laminated structure is modified to have, laminated on one surface thereof, an antifogging layer, an antistatic layer or the like, and have, laminated on the other surface thereof, an adhesive layer, to thereby obtain an antireflection film, and the thus obtained antireflection film is adhered to a liquid crystal display or the like. Specifically, if desired, the silica-containing laminated structure may have, laminated thereon, at least one layer other than the porous silica layer, to thereby obtain an antireflection film, and the thus obtained antireflection film can be used in various application fields in which it is required to prevent glaring and/or improve the light transmittance, such as the fields of eye-glasses (e.g., lenses of eye-glasses, lenses of goggles and contact lenses); automobiles (e.g., windows of an automobile, instrumental panels and a navigation system); housing and building (e.g., a windowpane); agriculture (e.g., a light transmitting film or sheet for a greenhouse); devices relating to energy (e.g., a solar battery, a photocell and laser); electronic information devices (e.g., a cathode-ray tube, a notebook computer, an electronic organizer/notebook, a touch screen, a liquid crystal television, a liquid crystal display, a portable television for automobiles, a liquid crystal display video player, a projection television, a plasma display, a plasma address liquid crystal display, a field emission display, an organic/inorganic electroluminescence (EL) display, a light emitting diode display, an optical fiber and an optical disc); household articles (e.g., a lighting globe, a fluorescent light, a mirror and a clock); business articles (e.g., a showcase, a picture frame, semiconductor lithography and a copying machine); and amusement articles (e.g., a liquid crystal display game machine, a glass lid of a pinball machine, and other game machines).

An antireflection film which is formed using the coating composition of the present invention has a refractive index as low as less than 1.30, thereby rendering it possible to achieve a reflectance as low as 0.5% or less.

Further, the antireflection film of the present invention exhibits a haze value advantageously as low as 2.0% or less, and the haze value can be even as low as 1.0% or less or 0.8% or less, depending on the production conditions.

The antireflection film of the present invention is characterized in the use of moniliform silica strings. The siloxane linkages bonding together the primary silica particles which constitute the moniliform silica strings have strong resistance against alkali. On the other hand, siloxane linkages generated after formation of the porous silica layer, namely, siloxane linkages which are formed between mutually adjacent moniliform silica strings and siloxane linkages which are derived from the hydrolyzable group-containing silane, tend to suffer breakage by alkali. Therefore, when the antireflection film of the present invention is placed in a strong alkali solution exhibiting a pH value of about 13, although the porous silica layer may become dispersed in the alkali solution to form a dispersion, the moniliform silica strings can still be observed in the dispersion. This is also a characteristic feature of the antireflection film of the present invention.

### BEST MODE FOR CARRYING OUT THE INVENTION

Hereinbelow, the present invention will be described in more detail with reference to the following Examples and Comparative Examples, which should not be construed as limiting the scope of the present invention.

(I) In the following Examples and Comparative Examples, (II) the below-mentioned polyethylene terephthalate (PET) film was used as a material for a transparent thermoplastic resin substrate (hereinafter, frequently referred to as “transparent substrate”):

a PET film having a thickness of 188 μm, wherein each surface thereof was subjected to a treatment for facilitating subsequent adhesion (trade name: COSMOSHINE™ A4300; manufactured and sold by Toyobo Co., Ltd., Japan) (heat resistance temperature: about 150° C.; refractive index (equivalent refractive index): 1.55; pencil hardness: HB).

(II) In the following Examples and Comparative Examples, various properties of a silica-containing laminated structure were measured by the following methods.

(1) Measurement of Absolute Reflectance

A portion of the undersurface of a silica-containing laminated structure (i.e., a portion of the surface remote from the porous silica layer) was roughened with sandpaper and the roughened surface was coated with black ink, so as to prevent incident light rays from being reflected on the undersurface of the laminate structure. Then, the absolute reflectance at an incidence angle of 12° was measured using a spectrophotometer (trade name: MPC-2200; manufactured and sold by Shimadzu Corporation, Japan).

(2) Measurement of Refractive Index

The refractive index of a porous silica layer was determined by a calculation based on the shape of the spectral reflectance curve obtained with respect to the results of the above-mentioned measurement of the absolute reflectance. Specifically, the calculation was conducted using a VBA program for analysis of optical properties of multilayer films, wherein the program was distributed in the seminar entitled “Basics of analysis and design of optical thin films (Kogaku hakumaku no kaiseki to sekkei no kiso)” held in the period of Aug. 2 and 3, 2001 by Johokiko Co., Ltd., Japan.

(3) Measurement of Haze

The haze was measured by a turbidimeter (trade name: NDH2000; manufactured and sold by Nippon Denshoku Industries Co., Ltd., Japan), in accordance with JIS K7361-1.

(4) Measurement of Water Contact Angle

The water contact angle was measured by an automatic analyzer for measuring solid surface energy (model CA-VE; manufactured and sold by Kyowa Interface Science Co., Ltd., Japan).

(5) Measurement of Pencil Hardness

The pencil hardness was measured in accordance with JIS K5400 under a load of 1 kg, using a testing pencil as defined in JIS S6006.

### EXAMPLE 1

A surface of the above-mentioned PET film was coated with a commercially available hard coat layer-forming agent (trade name: UVHC1101; manufactured and sold by GE Toshiba Silicones Co., Ltd., Japan) using a spin coater. Then, the resultant coating on the PET film was cured by irradiating ultraviolet rays for 120 seconds using a fluorescent lamp (trade name: GL-20; manufactured and sold by Toshiba Corporation, Japan) (illumination intensity at a wavelength of 250 nm: 4 mW/cm²), to thereby form a hard coat layer having a thickness of 5 μm. The resultant PET film having a hard coat layer formed thereon was used as a transparent substrate. The pencil hardness of this transparent substrate was 3H.

4 g of an aqueous dispersion of moniliform silica strings which each comprise primary silica particles having an average particle diameter of about 15 nm and which have an average length of about 170 nm (trade name: Snowtex™ OUP; manufactured and sold by Nissan Chemical Industries, Ltd., Japan) (solid silica content: 15% by weight), was mixed with 36 g of ethanol at room temperature, to thereby obtain a water/ethanol dispersion of moniliform silica strings which has a solid silica content of 1.5% by weight. To the obtained water/ethanol dispersion of moniliform silica strings was dropwise added 0.2 g of tetraethoxysilane while stirring at room temperature, and 0.1 g of a 1.64% by weight aqueous nitric acid solution was further dropwise added thereto while stirring at room temperature, followed by stirring for 1 hour at room temperature, thereby obtaining a coating composition for use in forming a porous silica layer.

Subsequently, the above-obtained coating composition was coated on the above-mentioned transparent substrate at room temperature by a spin coating method, followed by drying at 120° C. for 2 minutes using a forced convection oven, thereby obtaining a laminated structure comprising a transparent substrate and a porous silica layer formed thereon. The obtained laminated structure exhibited a minimum reflectance as small as 0.10% at a wavelength of 550 nm, whereas the minimum reflectance (at 550 nm) of the transparent substrate per se (i.e., the minimum reflectance as measured in the absence of the porous silica layer) was separately found to be as high as 3.5%. Various properties (including the minimum reflectance) of the laminated structure are shown in Table 1. The refractive index n of the porous silica layer was 1.27. The haze was 0.8%, which is good. The pencil hardness was 2H, which is also good.

### EXAMPLE 2

Substantially the same procedure as in Example 1 was repeated except that the aqueous dispersion of moniliform silica strings (trade name: Snowtex™ OUP; manufactured and sold by Nissan Chemical Industries, Ltd., Japan) (solid silica content: 15% by weight) was replaced by another product of aqueous dispersion of moniliform silica strings (trade name: Snowtex™ PS-SO; manufactured and sold by Nissan Chemical Industries, Ltd., Japan) (solid silica content: 15% by weight; average particle diameter of primary particles: about 15 nm; average length of moniliform silica strings: about 120 nm). Various properties of the obtained laminated structure are shown in Table 1. The laminated structure exhibited a minimum reflectance of 0.10% at a wavelength of 550 nm. The pencil hardness was 2H. The refractive index n of the porous silica layer was 1.27. The haze was 0.9%, which is good.

### EXAMPLE 3

Substantially the same procedure as in Example 1 was repeated except that the water/ethanol dispersion of moniliform silica strings was replaced by a water/ethanol dispersion of both moniliform silica strings and separate, non-linked silica particles, wherein the dispersion used in this Example 3 was obtained by mixing together 2.8 g of an aqueous dispersion of moniliform silica strings (trade name: Snowtex™ OUP; manufactured and sold by Nissan Chemical Industries, Ltd., Japan) (solid silica content: 15% by weight), 1.8 g of an aqueous dispersion of separate, non-linked silica particles (trade name: Snowtex™ OXS; manufactured and sold by Nissan Chemical Industries, Ltd., Japan) (solid silica content: 10% by weight) and 35.4 g of ethanol. Various properties of the obtained laminated structure are shown in Table 1. The laminated structure exhibited a minimum reflectance of 0.20% at a wavelength of 550 nm. The pencil hardness was 2H. The refractive index n of the porous silica layer was 1.28. The haze was 0.8%, which is good.

### EXAMPLE 4

Substantially the same procedure as in Example 1 was repeated except that the commercially available hard coat layer-forming agent (trade name: UVHC1101; manufactured and sold by GE Toshiba Silicones Co., Ltd., Japan) was replaced by another product of hard coat layer-forming agent (trade name: KAYANOVA FOP-1100; manufactured and sold by Nippon Kayaku Co., Ltd., Japan), and that the coating (of the hard coat layer-forming agent) formed on the PET film was cured by irradiating ultraviolet rays for 360 seconds using a photo surface processor (trade name: PL16-110; manufactured and sold by Sen Engineering Co., Ltd., Japan) (illumination intensity at a wavelength of 250 nm: 13 mW/cm²), thereby forming a hard coat layer having a thickness of 8 μm. The hard coat layer of the obtained transparent substrate had a water contact angle of 47° and a pencil hardness of 2H. The coating composition was able to be coated on the entire surface of the transparent substrate, i.e., the coating formability of the coating composition is good. Various properties of the obtained laminated structure are shown in Table 1 and Table 3. The laminated structure exhibited a minimum reflectance of 0.10% at a wavelength of 550 nm. The pencil hardness was 2H, which is good. The refractive index n of the porous silica layer was 1.26. The haze was 0.5%, which is good.

### COMPARATIVE EXAMPLE 1

Substantially the same procedure as in Example 1 was repeated except that the water/ethanol dispersion of moniliform silica strings was replaced by a water/ethanol dispersion of separate, non-linked silica particles, wherein the dispersion used in this Comparative Example 1 was obtained by mixing together 3 g of an aqueous dispersion of separate, non-linked spherical silica particles having an average particle diameter of 12 nm (trade name: Snowtex™ O; manufactured and sold by Nissan Chemical Industries, Ltd., Japan) (solid silica content: 20% by weight) and 37 g of ethanol. Various properties of the obtained laminated structure are shown in Table 1. The pencil hardness of the laminated structure was 2H. The haze was 0.8%. The laminated structure exhibited a minimum reflectance at a wavelength of 550 nm. However, the minimum reflectance was disadvantageously as high as 0.80%. Further, the refractive index n of the porous silica layer was 1.35, which is outside the range required in the present invention.

### EXAMPLE 5

A surface of the above-mentioned PET film was coated with a commercially available hard coat layer-forming agent (trade name: UVHC1101; manufactured and sold by GE Toshiba Silicones Co., Ltd., Japan) using a spin coater. Then, the resultant coating on the PET film was cured by irradiating ultraviolet rays for 120 seconds using a fluorescent lamp (trade name: GL-20; manufactured and sold by Toshiba Corporation, Japan) (illumination intensity at a wavelength of 250 nm: 4 mW/cm²), to thereby form a hard coat layer having a thickness of 5 μm. The resultant PET film having a hard coat layer formed thereon was used as a transparent substrate. The pencil hardness of this transparent substrate was 3H.

4 g of an aqueous dispersion of moniliform silica strings which each comprise primary silica particles having an average particle diameter of about 15 nm and which have an average length of about 170 nm (trade name: Snowtex™ OUP; manufactured and sold by Nissan Chemical Industries, Ltd., Japan) (solid silica content: 15% by weight) was mixed with 36 g of ethanol at room temperature, to thereby obtain a water/ethanol dispersion of moniliform silica strings which has a solid silica content of 1.5% by weight. To the obtained water/ethanol dispersion of moniliform silica strings was dropwise added 0.2 g of tetraethoxysilane while stirring at room temperature and, then, 0.1 g of a 1.64% by weight aqueous nitric acid solution was further dropwise added thereto while stirring at room temperature, followed by stirring at room temperature for 6 hours, thereby obtaining a coating composition for use in forming a porous silica layer.

Subsequently, the above-obtained coating composition was coated on the above-mentioned transparent substrate at room temperature by a spin coating method, followed by drying at 120° C. for 2 minutes using a forced convection oven, thereby obtaining a laminated structure comprising a transparent substrate and a porous silica layer formed thereon. The obtained laminated structure exhibited a minimum reflectance as small as 0.10% at a wavelength of 550 nm, whereas the minimum reflectance (at 550 nm) of the transparent substrate per se (i.e., the minimum reflectance as measured in the absence of the porous silica layer) was separately found to be as high as 3.5%. Various properties (including the minimum reflectance) of the laminated structure are shown in Table 2. The refractive index n of the porous silica layer was 1.27. The haze was 0.8%, which is good. The pencil hardness was 2H, which is also good.

### EXAMPLE 6

Substantially the same procedure as in Example 5 was repeated except that the aqueous dispersion of moniliform silica strings (trade name: Snowtex™ OUP; manufactured and sold by Nissan Chemical Industries, Ltd., Japan) (solid silica content: 15% by weight) was replaced by another product of aqueous dispersion of moniliform silica strings (trade name: Snowtex™ PS-SO; manufactured and sold by Nissan Chemical Industries, Ltd., Japan) (solid silica content: 15% by weight; average particle diameter of primary particles: about 15 nm; average length of moniliform silica strings: about 120 nm). Various properties of the obtained laminated structure are shown in Table 2. The laminated structure exhibited a minimum reflectance of 0.10% at a wavelength of 550 nm. The pencil hardness was 2H. The refractive index n of the porous silica layer was 1.27. The haze was 0.9%, which is good.

### EXAMPLE 7

Substantially the same procedure as in Example 5 was repeated except:

that the commercially available hard coat layer-forming agent (trade name: UVHC1101; manufactured and sold by GE Toshiba Silicones Co., Ltd., Japan) was replaced by another product of hard coat layer-forming agent (trade name: KAYANOVA ACH01; manufactured and sold by Nippon Kayaku Co., Ltd., Japan); and

that the coating (of the hard coat layer forming-agent) formed on the PET film was subjected to heating at 120° C. for 1 minute, and then cured by irradiating ultraviolet rays for 180 seconds using a photo surface processor (trade name: PL16-110; manufactured and sold by Sen Engineering Co., Ltd., Japan) (illumination intensity at a wavelength of 250 nm: 13 mW/cm²), thereby forming a hard coat layer having a thickness of 8 μm. The obtained transparent substrate had a pencil hardness of 2H. Various properties of the obtained laminated structure are shown in Table 2. The laminated structure exhibited a minimum reflectance of 0.10% at a wavelength of 550 nm. The pencil hardness was 2H. The refractive index n of the porous silica layer was 1.27. The haze was 0.7%, which is good.

### EXAMPLE 8

Substantially the same procedure as in Example 5 was repeated except that the amount of tetraethoxysilane was changed from 0.2 g to 0.6 g, and that the amount of the 1.64% by weight aqueous nitric acid solution was changed from 0.1 g to 0.3 g. Various properties of the obtained laminated structure are shown in Table 2. The laminated structure exhibited a minimum reflectance of 0.45% at a wavelength of 550 nm. The pencil hardness was 2H. The refractive index n of the porous silica layer was 1.29. The haze was 0.8%, which is good.

### EXAMPLE 9

Substantially the same procedure as in Example 5 was repeated except:

that the commercially available hard coat layer-forming agent (trade name: UVHC1101; manufactured and sold by GE Toshiba Silicones Co., Ltd., Japan) was replaced by another product of hard coat layer-forming agent (trade name: KAYANOVA FOP-1100; manufactured and sold by Nippon Kayaku Co., Ltd., Japan); that the coating (of the hard coat layer-forming agent) formed on the PET film was subjected to heating at 120° C. for 1 minute using a forced convection oven, and then cured by irradiating ultraviolet rays for 360 seconds using a photo surface processor (trade name: PL16-110; manufactured and sold by Sen Engineering Co., Ltd., Japan) (illumination intensity at a wavelength of 250 nm: 13 mW/cm²), thereby forming a hard coat layer having a thickness of 8 μm;

that the amount of tetraethoxysilane was changed from 0.2 g to 0.6 g; and

that the amount of the 1.64% by weight aqueous nitric acid solution was changed from 0.1 g to 0.3 g.

The obtained transparent substrate had a pencil hardness of 2H. Various properties of the obtained laminated structure are shown in Table 2. The laminated structure exhibited a minimum reflectance of 0.45% at a wavelength of 550 nm. The pencil hardness was 2H, which is good. The refractive index n of the porous silica layer was 1.29. The haze was 0.5%, which is good.

### COMPARATIVE EXAMPLE 2

A hard coat layer was formed on the PET film in the same manner as in Example 5, and the resultant PET film having a hard coat layer formed thereon was used as a transparent substrate. Then, 36 g of ethanol was mixed with 0.4 g of tetraethoxysilane while stirring at room temperature, and 0.1 g of a 1.64% by weight aqueous nitric acid solution was dropwise added thereto at room temperature, followed by stirring at room temperature for 6 hours, thereby effecting hydrolysis and dehydration-condensation of tetraethoxysilane. To the resultant reaction mixture was added 4 g of an aqueous dispersion of moniliform silica strings which each comprise primary silica particles having an average particle diameter of about 15 nm and which have an average length of about 170 nm (trade name: Snowtex™ OUP; manufactured and sold by Nissan Chemical Industries, Ltd., Japan) (solid silica content: 15% by weight), thereby obtaining a coating composition for use in forming a porous silica layer. Subsequently, the same procedure as in Example 5 was repeated except that the above-obtained coating composition was used, thereby obtaining a laminated structure comprising a transparent substrate and a porous silica layer formed thereon. Various properties of the obtained laminated structure are shown in Table 2. The laminated structure exhibited a minimum reflectance of 0.1% at a wavelength of 550 nm. The refractive index n of the porous silica layer was 1.27 and the haze was 0.8%, which are almost the same results as in Examples 5 to 9 above. However, the pencil hardness was H, which is low, as compared to the pencil hardness of the silica-containing laminated structure obtained in each of Examples 5 to 9 above. The reason for this difference in the pencil hardness is presumed to be that, in the case where a hydrolyzable group-containing silane is subjected to hydrolysis and dehydration-condensation prior to mixing thereof with moniliform silica strings (as in Comparative Example 2), the strength of the obtained laminated structure becomes disadvantageously low, as compared to the case where a hydrolyzable group-containing silane is subjected to hydrolysis and dehydration-condensation after mixing thereof with moniliform silica strings (as in Examples 5 to 9).

### COMPARATIVE EXAMPLE 3

Substantially the same procedure as in Comparative Example 2 was repeated except that the amount of tetraethoxysilane was changed from 0.2 g to 0.6 g, and that the amount of the 1.64% by weight aqueous nitric acid solution was changed from 0.1 g to 0.3 g. Various properties of the obtained laminated structure are shown in Table 2. The laminated structure exhibited a minimum reflectance of 0.40% at a wavelength of 550 nm. The refractive index n of the porous silica layer was 1.285 and the haze was 0.8%, which are almost the same results as in Examples 5 to 9 above. However, the pencil hardness was H, which is low, as compared to the pencil hardness of the silica-containing laminated structure obtained in each of Examples 5 to 9 above.

### EXAMPLE 10

Substantially the same procedure as in Example 4 was repeated except that the aqueous dispersion of moniliform silica strings (trade name: Snowtex™ OUP; manufactured and sold by Nissan Chemical Industries, Ltd., Japan) (solid silica content: 15% by weight) was replaced by another product of aqueous dispersion of moniliform silica strings which each comprise primary silica particles having an average particle diameter of about 15 nm and which have an average length of about 120 nm (trade name: Snowtex™ PS-SO; manufactured and sold by Nissan Chemical Industries, Ltd., Japan) (solid silica content: 15% by weight). Various properties of the obtained laminated structure are shown in Table 3. The obtained coating composition for use in forming a porous silica layer was able to be coated on the entire surface of the transparent substrate having a hard coat layer formed thereon, wherein the hard coat layer had a water contact angle of 47°, i.e., the coating formability of the coating composition is good. The obtained laminated structure exhibited a minimum reflectance of 0.10% at a wavelength of 550 nm. The pencil hardness was 2H. The refractive index n of the porous silica layer was 1.26. The haze was 0.6%, which is good.

### EXAMPLE 11

Substantially the same procedure as in Example 4 was repeated except:

that the commercially available hard coat layer-forming agent (trade name: KAYANOVA FOP-1100; manufactured and sold by Nippon Kayaku Co., Ltd., Japan) was replaced by another product of hard coat layer-forming agent (trade name: UVHC1101; manufactured and sold by GE Toshiba Silicones Co., Ltd., Japan);

that heating of the coating (of the hard coat layer-forming agent) on the PET film at 120° C. for 1 minute was not performed; and

that irradiation time for curing the coating (of the hard coat layer-forming agent) on the PET film was changed to 180 seconds.

The hard coat layer of the obtained transparent substrate had a thickness of 5 μm and a water contact angle of 38°. Various properties of the obtained laminated structure are shown in Table 3. The obtained coating composition for use in forming a porous silica layer was able to be coated on the entire surface of the transparent substrate, i.e., the coating formability of the coating composition is good. The laminated structure exhibited a minimum reflectance of 0.10% at a wavelength of 550 nm. The pencil hardness was 2H. The refractive index n of the porous silica layer was 1.27. The haze was 0.8%, which is good.

### EXAMPLE 12

Substantially the same procedure as in Example 4 was repeated except:

that the commercially available hard coat layer-forming agent (trade name: KAYANOVA FOP-1100; manufactured and sold by Nippon Kayaku Co., Ltd., Japan) was replaced by another product of hard coat layer-forming agent (trade name: UVHC1101; manufactured and sold by GE Toshiba Silicones Co., Ltd., Japan);

that heating of the coating (of the hard coat layer-forming agent) on the PET film at 120° C. for 1 minute was not performed; and

that the coating (of the hard coat layer-forming agent) on the PET film was cure by irradiating ultraviolet rays for 360 seconds using a fluorescent lamp (trade name: GL-20; manufactured and sold by Toshiba Corporation, Japan) (illumination intensity at a wavelength of 250 nm: 4 mW/cm²).

The hard coat layer of the obtained transparent substrate had a water contact angle of 73°. Various properties of the obtained laminated structure are shown in Table 3. The obtained coating composition for use in forming a porous silica layer was able to be coated on the entire surface of the transparent substrate, i.e., the coating formability of the coating composition is good. The laminated structure exhibited a minimum reflectance of 0.20% at a wavelength of 550 nm, and the pencil hardness was 2H, which is good. The refractive index n of the porous silica layer was 1.28. The haze was 0.8%, which is also good.

### EXAMPLE 13

To 100 parts by weight of a commercially available, UV-curable silicone hard coat layer-forming agent (trade name: X-12-2400; manufactured and sold by Shin-Etsu Chemical Co., Ltd., Japan) was added 5 parts by weight of a polymerization initiator (trade name: DX2400; manufactured and sold by Shin-Etsu Chemical Co., Ltd., Japan), thereby obtaining a coating composition for forming a hard coat layer. A surface of the above-mentioned PET film was coated with the above-obtained coating composition for forming a hard coat layer using a bar coater, followed by drying at 100° C. for 1 minute. Then, the resultant coating on the PET film was cured by irradiating ultraviolet rays, to thereby form a hard coat layer having a thickness of 4 μm. The resultant PET film having a hard coat layer formed thereon was used as a transparent substrate.

1 g of an aqueous dispersion of moniliform silica strings which each comprise primary silica particles having an average particle diameter of about 12 nm and which have an average length of about 100 nm (trade name: Snowtex™ OUP; manufactured and sold by Nissan Chemical Industries, Ltd., Japan) (solid silica content: 15% by weight), was mixed with 9 g of ethanol at room temperature, to thereby obtain a water/ethanol dispersion of moniliform silica strings which has a solid silica content of 1.5% by weight. To the obtained water/ethanol dispersion of moniliform silica strings was dropwise added 0.092 g of a 10% by weight aqueous solution of calcium chloride dihydrate while stirring at room temperature, thereby obtaining a coating composition for use in forming a porous silica layer.

Subsequently, the above-obtained coating composition for use in forming a porous silica layer was coated on the above-mentioned transparent substrate at room temperature by a spin coating method, followed by heating at 120° C. for 2 minutes using a forced convection oven, thereby obtaining a laminated structure comprising a transparent substrate and, formed thereon, a porous silica layer having a thickness of 108 nm.

The obtained laminated structure exhibited a minimum reflectance as small as 0.15% at a wavelength of 550 nm, whereas the minimum reflectance (at 550 nm) of the transparent substrate per se (i.e., the minimum reflectance as measured in the absence of the porous silica layer) was separately found to be as high as 3.4%. Various properties (including the minimum reflectance) of the laminated structure are shown in Table 4. The haze of the laminated structure was 0.15%, which is good. The pencil hardness was 2H, which is also good. The molar ratio of calcium chloride to silicon atoms was 0.025.

### EXAMPLE 14

Substantially the same procedure as in Example 13 was repeated except that 0.127 g of a 10% by weight aqueous solution of magnesium chloride hexahydrate was used instead of 0.092 g of a 10% by weight aqueous solution of calcium chloride dihydrate. Various properties of the obtained laminated structure are shown in Table 4. The laminated structure exhibited a minimum reflectance of 0.15% at a wavelength of 550 nm. The haze was 0.20%. The pencil hardness was 2H, which is good. The molar ratio of magnesium chloride to silicon atoms was 0.025.

### EXAMPLE 15

Substantially the same procedure as in Example 13 was repeated except that 0.20 g of a 10% by weight aqueous solution of calcium chloride tetrahydrate was used instead of 0.092 g of a 10% by weight aqueous solution of calcium chloride dihydrate. Various properties of the obtained laminated structure are shown in Table 4. The laminated structure exhibited a minimum reflectance of 0.20% at a wavelength of 550 nm. The haze was 0.20%. The pencil hardness was H. The molar ratio of calcium chloride to silicon atoms was 0.054.

### EXAMPLE 16

Substantially the same procedure as in Example 13 was repeated except that the water/ethanol dispersion of moniliform silica strings was replaced by a water/ethanol dispersion of both moniliform silica strings and separate, non-linked silica particles, wherein the dispersion used in this Example 16 was obtained by mixing together 0.5 g of an aqueous dispersion of moniliform silica strings (trade name: Snowtex™ OUP; manufactured and sold by Nissan Chemical Industries, Ltd., Japan) (solid silica content: 15% by weight), 0.75 g of an aqueous dispersion of separate, non-linked silica particles (trade name: Snowtex™ OXS; manufactured and sold by Nissan Chemical Industries, Ltd., Japan) (solid silica content: 10% by weight) and 8.75 g of ethanol. Various properties of the obtained laminated structure are shown in Table 4. The laminated structure exhibited a minimum reflectance of 0.20% at a wavelength of 550 nm. The haze was 0.20% and the pencil hardness was 2H. The molar ratio of calcium chloride to silicon atoms present in the moniliform silica strings was 0.025.

### COMPARATIVE EXAMPLE 4

Substantially the same procedure as in Example 13 was repeated except:

that the water/ethanol dispersion of moniliform silica strings was replaced by a water/ethanol dispersion of separate, non-linked silica particles, wherein the dispersion used in this Comparative Example 4 was obtained by mixing together 0.75 g of an aqueous dispersion of separate, non-linked silica particles having an average particle diameter of 12 nm (trade name: Snowtex™ O; manufactured and sold by Nissan Chemical Industries, Ltd., Japan) (solid silica content: 20% by weight) and 9.25 g of ethanol;

and that a 10% by weight aqueous solution of calcium chloride dihydrate was not added.

Various properties of the obtained laminated structure are shown in Table 4. In this Comparative Example 4, it was attempted to apply the coating composition onto the transparent substrate by a spin coating method; however, cissings were formed, i.e., the coating formability of the coating composition is poor. With respect to a coated portion of the transparent substrate, the pencil hardness was measured; however, the coated portion suffered scratches even with an HB pencil.

### COMPARATIVE EXAMPLE 5

Substantially the same procedure as in Example 13 was repeated except that the water/ethanol dispersion of moniliform silica strings was replaced by a water/ethanol dispersion of separate, non-linked silica particles, wherein the dispersion used in this Comparative Example 5 was obtained by mixing together 0.75 g of an aqueous dispersion of separate, non-linked silica particles having an average particle diameter of about 12 nm (trade name: Snowtex™ O; manufactured and sold by Nissan Chemical Industries, Ltd., Japan) (solid silica content: 20% by weight) and 9.25 g of ethanol. The pencil hardness of the obtained laminated structure was 2H, which is improved, as compared to the pencil hardness of the laminated structure obtained in Comparative Example 4 above. However, the laminated structure exhibited a minimum reflectance of 0.8% at a wavelength of 550 nm, which is disadvantageously high, as compared to the results obtained in Examples 4 and 10 to 12. The molar ratio of calcium chloride to silicon atoms was 0.025.

### EXAMPLE 17

1 g of an aqueous dispersion of moniliform silica strings which each comprise primary silica particles having an average particle diameter of about 12 nm and which have an average length of about 100 nm (trade name: Snowtex™ OUP; manufactured and sold by Nissan Chemical Industries, Ltd., Japan) (solid silica content: 15% by weight) was mixed with 9 g of ethanol at room temperature, to thereby obtain a water/ethanol dispersion of moniliform silica strings which has a solid silica content of 1.5% by weight. To the obtained water/ethanol dispersion of moniliform silica strings was dropwise added a 0.1 N nitric acid while stirring at room temperature, wherein the amount of nitric acid was adjusted so that the concentration of nitric acid in the resultant mixture became 0.0010 mol/liter, thereby obtaining a coating composition for use in forming a porous silica layer.

Subsequently, the above-obtained coating composition was coated on the above-mentioned transparent substrate at room temperature by a spin coating method, followed by heating at 120° C. for 2 minutes using a forced convection oven, thereby obtaining a laminated structure comprising a transparent substrate and a porous silica layer formed thereon.

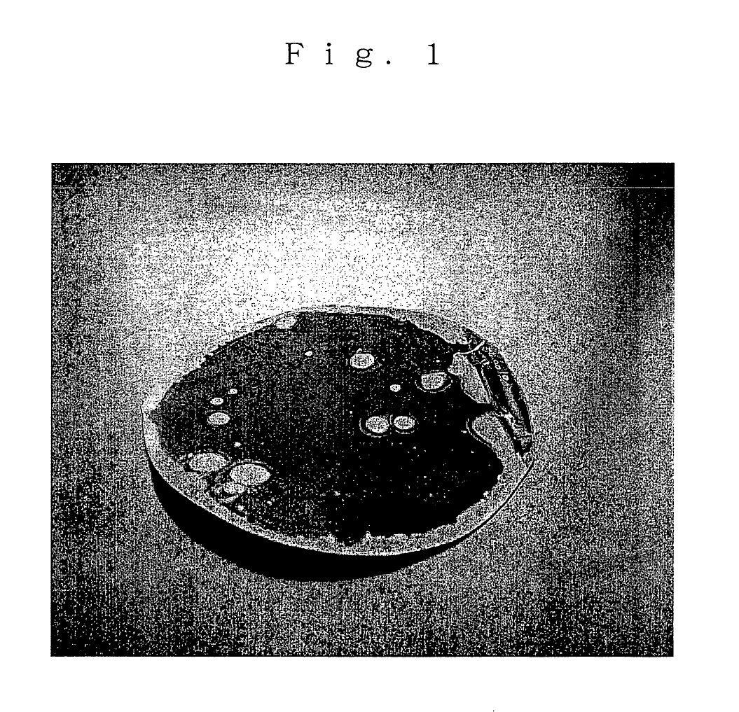

The undersurface of the obtained silica-containing laminated structure (i.e., the surface remote from the porous silica layer) was coated with a black spray paint (trade name: Acrylic Lacquer Spray Paint, Matte Black; manufactured and sold by Asahipen Corp., Japan) and, then, the appearance of a low refractivity coating formed on the undersurface was observed. As shown in Table 5 and FIG. 1, although some defects were observed on the low refractivity coating, the low refractivity coating had a fairly good appearance, i.e., the coating formability of the coating composition produced in this Example 17 was fairly good.

### EXAMPLES 18 TO 20

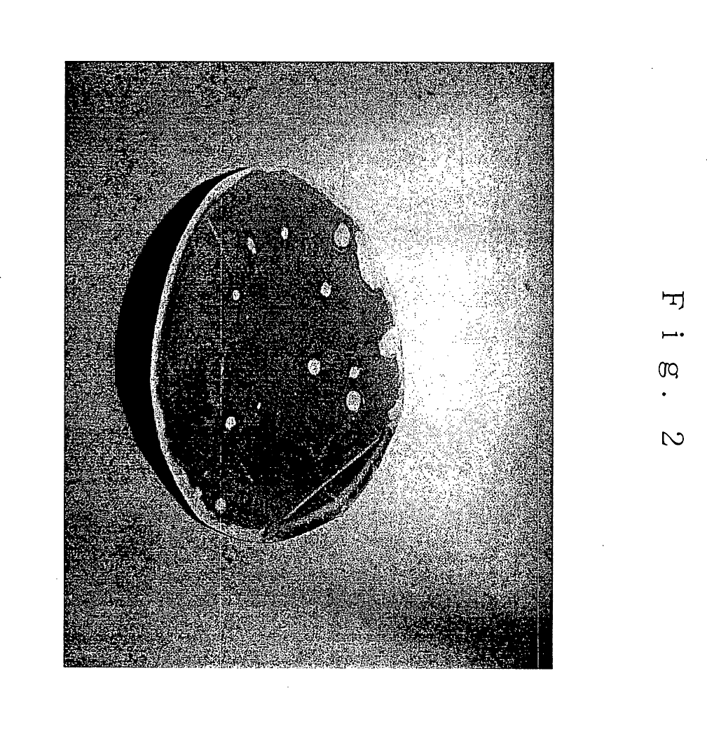

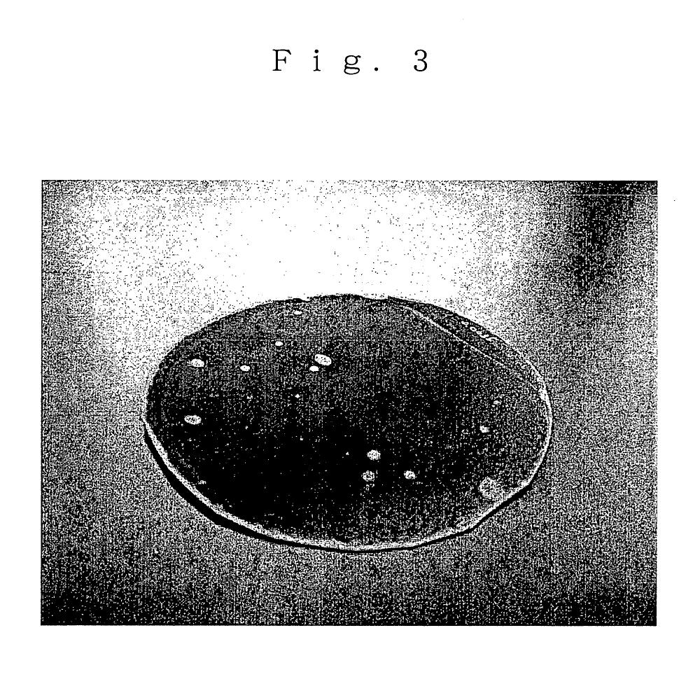

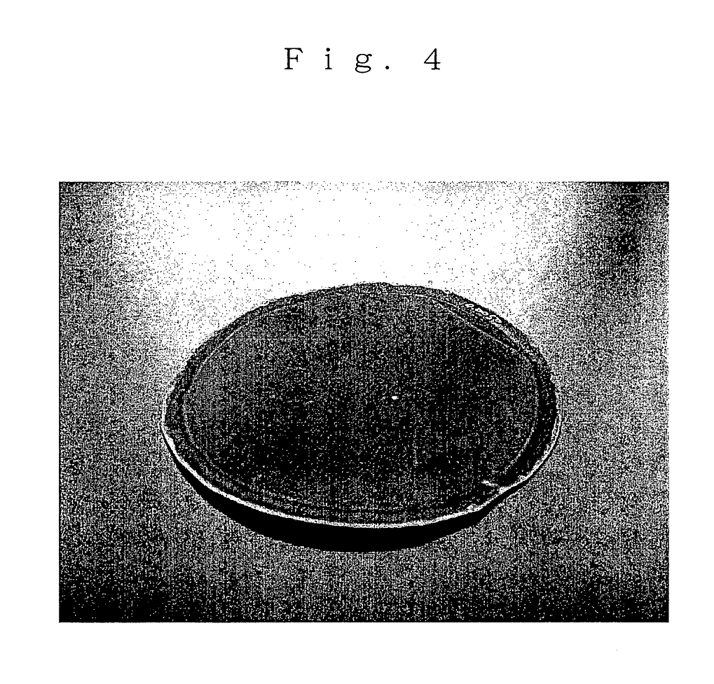

For Examples 18 to 20, substantially the same procedure as in Example 17 was repeated except that the amount of nitric acid was varied so as to obtain three coating compositions containing nitric acid in concentrations of 0.0020 mol/liter, 0.0035 mol/liter and 0.0050 mol/liter, respectively. As shown in Table 5 and FIGS. 2 to 4, the coating formability of the coating composition produced in each of Examples 18 to 20 was good.

### EXAMPLE 21

Into a 50 liter reaction vessel equipped with a condenser, an agitation blade having a motor, and a thermostatic circulation water bath were charged 6.67 kg of an aqueous dispersion of moniliform silica strings which each comprise primary silica particles having an average particle diameter of about 15 nm and which have an average length of about 170 nm (trade name: Snowtex™ OUP; manufactured and sold by Nissan Chemical Industries, Ltd., Japan) (solid silica content: 15% by weight) and 13.33 kg of ethanol, to mix the aqueous dispersion and the ethanol together at room temperature, thereby obtaining a water/ethanol dispersion of moniliform silica strings which has a solid silica content of 5% by weight. Then, 347 g of tetraethoxysilane, 368 g of a 10% by weight aqueous solution of calcium chloride dihydrate and 192 g of a 1.64% by weight aqueous nitric acid solution were dropwise added in this order to the above-obtained water/ethanol dispersion of moniliform silica strings at room temperature while stirring. The temperature of the resultant mixture was elevated to 75° C. over 4 hours, followed by stirring at 75° C. for 3.5 hours, thereby obtaining a coating composition for use in forming a porous silica layer.

Subsequently, the above-obtained coating composition was coated on the above-mentioned PET film by a spin coating method, followed by drying at 120° C. for 2 minutes using a forced convection oven, thereby obtaining a laminated structure comprising a PET film and a porous silica layer formed thereon. The obtained laminated structure exhibited a minimum reflectance of 0.05% at a wavelength of 570 nm. The haze was 0.5%.

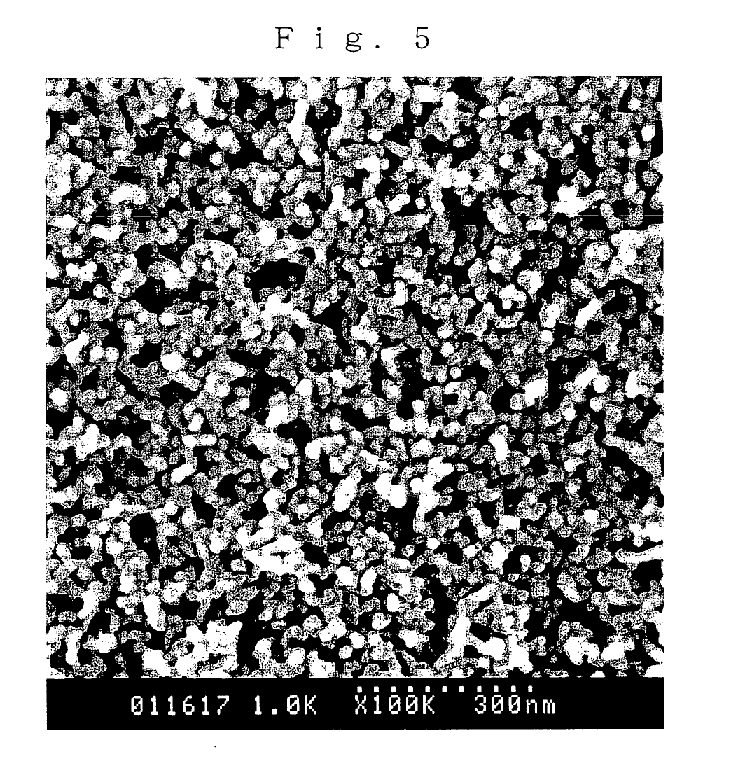

The obtained laminated structure was plasma-coated with osmium in a thickness of from 1.5 to 2 nm, to thereby impart electroconductivity to the laminated structure. Then, the surface of the laminated structure (i.e., the porous silica layer) was observed using a scanning electron microscope (trade name: S-900; manufactured and sold by Hitachi, Ltd., Japan) at an acceleration voltage of 1.0 kV. FIG. 5 is a photomicrograph of the porous silica layer at a magnification of about 100,000 times.

With respect to the photomicrograph, analysis of the size of pores was performed using an image analysis software “Azokun™” (manufactured and sold by Asahi Kasei Kabushiki Kaisha, Japan). Specifically, the analysis was performed as follows. The photomicrograph was subjected to second-order differentiation, to thereby obtain a photomicrograph in which the outlines of the images of silica particles are enhanced. From the obtained enhanced photomicrograph, 73 images of primary silica particles constituting moniliform silica strings, each of the images having a roundness parameter of 110 or more as measured by the image analysis software, were automatically selected. Then, the distribution of the areas of the selected images in the photomicrograph was analyzed. The average value of the areas of the selected images (i.e., average value of the respective maximum cross-sectional areas of the primary silica particles) was designated as (a₂), and the standard deviation of the areas of the selected images (i.e., standard deviation of the measured values of the respective maximum cross-sectional areas of the primary silica particles) was designated as σ. It was found that (a₂)=344.4 nm², that σ=138.7 nm², and that (a₂+3σ)=760.4 nm².

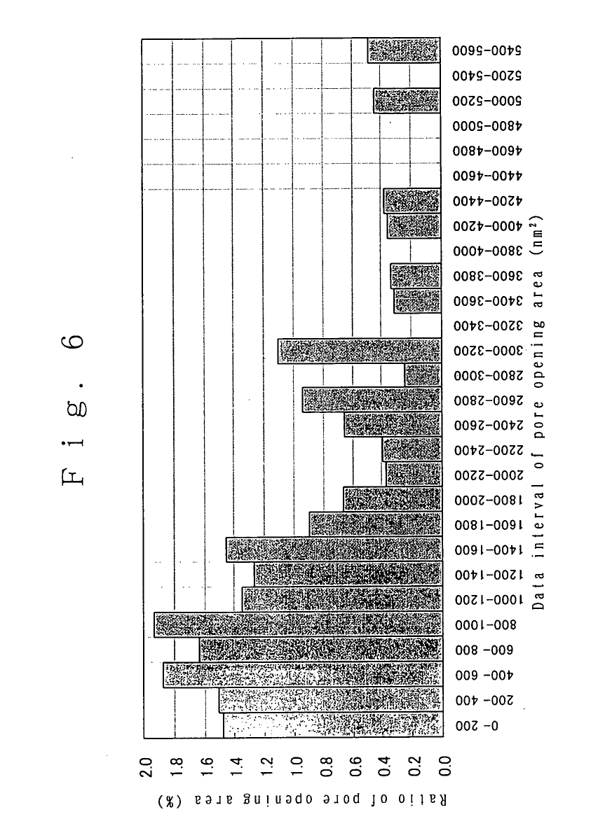

Subsequently, the luminance distribution of the photomicrograph was calculated, and the portions of the photomicrograph where the luminance is not more than the value represented by the formula: L+(PB−L)/3 (wherein PB represents the peak luminance and L represents the minimum luminance), were defined as pores. The photomicrograph was subjected to mapping with respect to the images of pores therein, to thereby count the number of pores and calculate the pore opening area of each of the pores. FIG. 6 is a graph showing the distribution of pore opening areas in the photomicrograph. As a result, it was found that the total ratio (S) of pore opening areas of all pores in the photomicrograph was 20.08%, that the total ratio (S_{(a2+3σ)}) of pore opening areas of pores each having a pore opening area which is (a₂+3σ) or more was 13.73%, and that (S_{(a2+3σ)})/(S) was 0.68.

### COMPARATIVE EXAMPLE 6

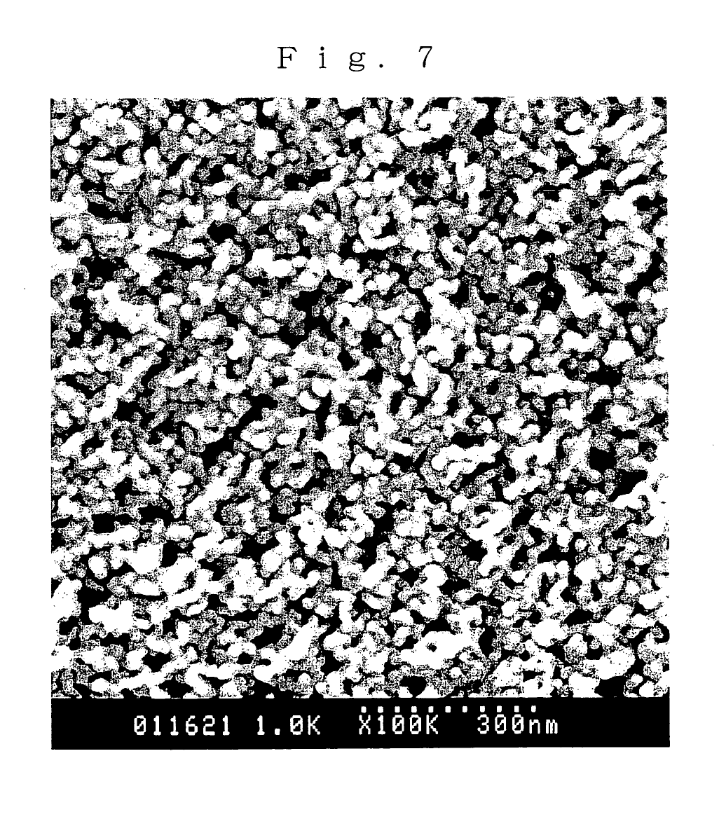

The coating composition obtained in Example 21 above was coated on a glass substrate by a spin coating method. Then, the resultant coating was dried at 120° C. for 2 minutes using a forced convection oven, followed by heating using a muffle furnace at 250° C. for 30 minutes, and then at 500° C. for 1 hour, thereby obtaining a laminated structure comprising a glass substrate and a porous silica layer formed thereon. The obtained laminated structure exhibited a minimum reflectance of 0.45% at a wavelength of 560 nm. The haze was 0.4%. The laminated structure was observed in the same manner as in Example 21 above using an electron microscope at an acceleration voltage of 1.0 kV. FIG. 7 is a photomicrograph of the porous silica layer at a magnification of about 100,000 times.

With respect to the photomicrograph, analysis of the size of pores was performed in substantially the same manner as in Example 21. Specifically, the analysis was performed as follows. The photomicrograph was subjected to second-order differentiation, to thereby obtain a photomicrograph in which the outlines of the images of silica particles are enhanced. From the obtained enhanced photomicrograph, 28 images of primary silica particles, each having a roundness parameter value of 110 or more as measured by the image analysis software, were automatically selected. Then, the distribution of the areas of the selected images in the photomicrograph was analyzed, and it was found that (a₂)=401.3 nm², that σ=180.2 nm², and that (a₂+3σ)=941.9 nm².

Subsequently, analysis of pores was performed in the same manner as in Example 21 above. As a result, it was found that the total ratio (S) of pore opening areas of all pores in the photomicrograph was 11.93%, that the total ratio (S_{(a2+3σ)}) of pore opening areas of pores each having a pore opening area which is (a₂+3σ) or more was 4.87%, and that (S_{(a2+3σ)})/(S) was 0.41.

### COMPARATIVE EXAMPLE 7

15 g of an aqueous dispersion of separate, non-linked silica particles having an average particle diameter of about 10 nm (trade name: Snowtex™ O; manufactured and sold by Nissan Chemical Industries, Ltd., Japan) (solid silica content: 20% by weight) was mixed with 1.0 g of tetraethoxysilane (TEOS) at room temperature, followed by stirring at 25° C. for 20 hours. Then, 45 g of ethanol was added thereto, followed by stirring at room temperature for 10 minutes. To 1 g of the resultant reaction mixture was added 4 g of 2-propanol, followed by stirring at room temperature for 10 minutes, thereby obtaining a coating composition for use in forming a porous silica layer.

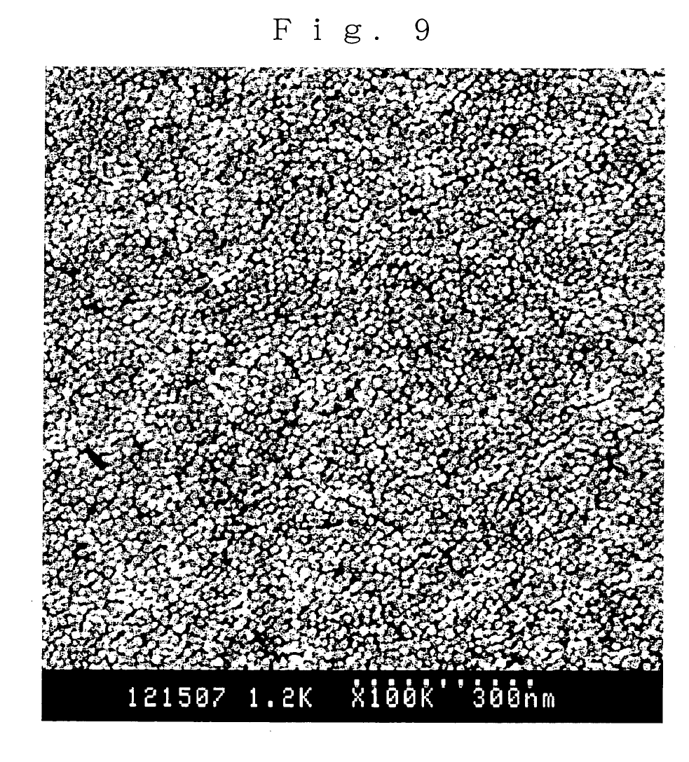

Subsequently, the above-obtained coating composition was coated on a PET film (thickness: about 50 μm) by a spin coating method, wherein the PET film had been subjected to a treatment for improving the mold release property thereof. The resultant coating on the PET film was dried at 120° C. for 2 minutes using a forced convection oven, thereby obtaining a laminated structure comprising a PET film and a porous silica layer formed on the PET film. Further, a zirconium oxide/indium oxide electroconductive layer, a urethane acrylate hard coat layer and a thermoplastic resin adhesive layer were formed in this order on the above-obtained laminated structure by a spin coating method. Onto the thermoplastic resin adhesive layer (which is the outermost layer) was superimposed a polymethyl methacrylate board having a thickness of about 2 mm, and the latter was adhered to the former at 145° C. From the resultant laminated structure (having the polymethyl methacrylate board positioned at the surface remote from the PET film), the PET film (which had been subjected to a treatment for improving the mold release property) was delaminated, thereby obtaining an antireflection film comprising a polymethyl methacrylate board and, laminated thereon in the following order, a thermoplastic resin adhesive layer, a urethane aclyrate hard coat layer, a zirconium oxide/indium oxide electroconductive layer and a porous silica layer. The obtained antireflection film was observed using an electronmicroscope in substantially the same manner as in Example 21 above at an acceleration voltage of 1.2 kV. FIG. 9 is a photomicrograph of the porous silica layer at a magnification of about 100,000 times.

With respect to the photomicrograph, analysis of the size of pores was performed in substantially the same manner as in Example 21. Specifically, the analysis was performed as follows. The photomicrograph was subjected to second-order differentiation, to thereby obtain a photomicrograph in which the outlines of the images of silica particles are enhanced. From the obtained photomicrograph, 608 images of primary silica particles, each having a roundness parameter of 110 or more as measured by the image analysis software, were automatically selected. Then, the distribution of the areas of the selected images in the photomicrograph was analyzed, and it was found that (a₂)=119.5 nm², that σ=35.05 nm², and that (a₂+3σ)=224.7 nm².

Subsequently, analysis of pores was performed in the same manner as in Example 21 above. As a result, it was found that the total ratio (S) of pore opening areas of all pores in the photomicrograph was 1.93%, that the total ratio (S_{(a2+3σ)}) of pore opening areas of pores each having a pore opening area which is (a₂+3σ) or more was 0.24%, and that (S_{(a2+3σ)})/(S) was 0.13.

TABLE 1

| | Hard coat | | | Refractive | Pencil | |
|---|---|---|---|---|---|---|
| | layer | Silica particles | Minimum reflectance | index | hardness | Haze |
| EX. 1 | UVHC1101 | Snowtex OUP (moniliform silica | 0.1% | 1.27 | 2H | 0.8% |
| | | strings) | | | | |
| Ex. 2 | UVHC1101 | Snowtex PS-SO (moniliform silica | 0.1% | 1.27 | 2H | 0.9% |
| | | strings) | | | | |
| Ex. 3 | UVHC1101 | Snowtex OUP (moniliform silica | 0.2% | 1.28 | 2H | 0.8% |
| | | strings) + Snowtex | | | | |
| | | OXS (separate, non- | | | | |
| | | linked silica particles) | | | | |
| | | (weight ratio of solids content = 7:3) | | | | |
| Ex. 4 | FOP-1100 | Snowtex OUP (moniliform silica | 0.1% | 1.26 | 2H | 0.5% |
| | | strings) | | | | |
| Comp. | UVHC1101 | Snowtex O (separate, non-linked | 0.8% | 1.35 | 2H | 0.8% |
| Ex. 1 | | silica particles) | | | | |

TABLE 2

| | | | hydrolyzable group- | | | | | |
|---|---|---|---|---|---|---|---|---|
| | Hard coat | | containing silane | | Minimum | Refractive | Pencil | |
| | layer | Silica particles | | Hydrolysis reaction | reflectance | index | hardness | Haze |
| Ex. 5 | UVHC1101 | Snowtex OUP (moniliform | TEOS | In the | 0.1% | 1.27 | 2H | 0.8% |
| | | silica strings) 4 g | 0.2 g | presence of | | | | |
| | | | | silica | | | | |
| Ex. 6 | UVHC1101 | Snowtex PS-SO (moniliform | TEOS | In the | 0.1% | 1.27 | 2H | 0.9% |
| | | silica strings) 4 g | 0.2 g | presence of | | | | |
| | | | | silica | | | | |
| Ex. 7 | ACH01 | Snowtex OUP (moniliform | TEOS | In the | 0.1% | 1.27 | 2H | 0.7% |
| | | silica strings) 4 g | 0.2 g | presence of | | | | |
| | | | | silica | | | | |
| Ex. 8 | UVHC1101 | Snowtex OUP (moniliform | TEOS | In the | 0.45% | 1.29 | 2H | 0.8% |
| | | silica strings) 4 g | 0.6 g | presence of | | | | |
| | | | | silica | | | | |
| Ex. 9 | FOP-1100 | Snowtex OUP (moniliform | TEOS | In the | 0.45% | 1.29 | 2H | 0.5% |
| | | silica strings) 4 g | 0.6 g | presence of | | | | |
| | | | | silica | | | | |
| Comp. | UVHC1101 | Snowtex OUP (moniliform | TEOS | Mixed with | 0.1% | 1.27 | H | 0.8% |
| Ex. 2 | | silica strings) 4 g | 0.4 g | silica after | | | | |
| | | | | hydrolysis | | | | |
| Comp. | UVHC1101 | Snowtex OUP (moniliform | TEOS | Mixed with | 0.4% | 1.29 | H | 0.8% |
| Ex. 3 | | silica strings) 4 g | 0.6 g | silica after | | | | |
| | | | | hydrolysis | | | | |

TABLE 3

| | Hard coat layer | | | | | | | |
|---|---|---|---|---|---|---|---|---|
| | | water contact | Silica | Appearance of | Minimum | Refractive | Pencil | |
| | | angle | particles | the coating | reflectance | index | hardness | Haze |
| Ex. 4 | FOP-1100 | 47° | Snowtex OUP | Uniform | 0.1% | 1.26 | 2H | 0.5% |
| | | | (moniliform | | | | | |
| | | | silica | | | | | |
| | | | strings) | | | | | |
| Ex. 10 | FOP-1100 | 47° | Snowtex | Uniform | 0.1% | 1.26 | 2H | 0.6% |
| | | | PS-SO (monilifrom | | | | | |
| | | | silica | | | | | |
| | | | strings) | | | | | |
| Ex. 11 | UVHC1101 | 38° | Snowtex OUP | Uniform | 0.1% | 1.27 | 2H | 0.8% |
| | | | (moniliform | | | | | |
| | | | silica | | | | | |
| | | | strings) | | | | | |
| Ex. 12 | UVHC1101 | 73° | Snowtex OUP | Uniform | 0.2% | 1.28 | 2H | 0.8% |
| | | | (moniliform | | | | | |
| | | | silica | | | | | |
| | | | strings) | | | | | |

TABLE 4

| | Hard coat | | Alkaline earth | Appearance of | Minimum | Pencil | |
|---|---|---|---|---|---|---|---|
| | layer | Silica particles | metal salt | the coating | reflectance | hardness | Haze |
| Ex. 13 | X-12-2400 | Snowtex OUP (moniliform | 10% CaCl₂.2H₂O | Uniform | 0.15% | 2H | 0.15% |
| | | silica strings) 1 g | 0.092 g | | | | |
| Ex. 14 | X-12-2400 | Snowtex OUP (moniliform | 10% MgCl₂.6H₂O | Uniform | 0.15% | 2H | 0.20% |
| | | silica strings) 1 g | 0.127 g | | | | |
| Ex. 15 | X-12-2400 | Snowtex OUP (moniliform | 10% CaCl₂.4H₂O 0.2 g | Uniform | 0.20% | H | 0.20% |
| | | silica strings) 1 g | | | | | |
| Ex. 16 | X-12-2400 | Snowtex OUP (moniliform | 10% CaCl₂.2H₂O | Uniform | 0.20% | 2H | 0.20% |
| | | silica strings) 0.5 g + Snowtex | 0.092 g | | | | |
| | | OXS (separate, | | | | | |
| | | non-linked silica particles) | | | | | |
| | | 0.75 g | | | | | |
| Comp. | X-12-2400 | Snowtex O (separate, | Not added | Cissings were | — | Lower than | — |
| Ex. 4 | | non-linked silica particles) | | observed | | HB | |
| | | 0.75 g | | | | | |
| Comp. | X-12-2400 | Snowtex O (separate, | 10% CaCl₂.2H₂O | Uniform | 0.80% | 2H | — |
| Ex. 5 | | non-linked silica particles) | 0.092 g | | | | |
| | | 0.75 g | | | | | |

TABLE 5

| | Acid concentration | |
|---|---|---|
| | (mol/l) | Appearance |
| Ex. 17 | 0.0010 | |
| Ex. 18 | 0.0020 | |
| Ex. 19 | 0.0035 | |
| Ex. 20 | 0.0050 | |

### INDUSTRIAL APPLICABILITY

In the silica-containing laminated structure of the present invention and the antireflection film of the present invention which comprises the silica-containing laminated structure, the porous silica layer formed on the substrate exhibits a reflectance of as low as 1.22 or more and less than 1.30, high light transmittance and excellent mechanical strength. Therefore, the silica-containing laminated structure and the antireflection film can be used as an optical part in various application fields, such as the fields of eye-glasses, automobiles, housing and building, agriculture, devices relating to energy, electronic information devices, household articles, business articles, and amusement articles.

Further, by using the coating composition of the present invention, it becomes possible to form an excellent porous silica layer at a temperature which is lower than that employed in the prior art and, hence, it has become possible to form a porous silica layer on an optical film or the like which has poor heat resistance and which cannot be used in the prior art.

1. A silica-containing laminated structure comprising a transparent thermoplastic resin substrate and, laminated thereon, at least one porous silica layer having a refractive index of 1.22 or more and less than 1.30,
wherein said at least one porous silica layer is comprised of a plurality of moniliform silica strings, each comprising a plurality of primary silica particles which are linked in rosary form, and
wherein the pores of said at least one porous silica layer include pores (P), each of said pores (P) having a pore opening area which is larger than the average value of the respective maximum cross-sectional areas of said primary silica particles, wherein said pore opening areas of said pores (P) are measured with respect to the pore openings in the surface or cross-section of said porous silica layer.

2. The silica-containing laminated structure according to claim 1, wherein said moniliform silica strings have an average length of from 30 to 200 nm in terms of the average value as measured by the dynamic light scattering method.

3. The silica-containing laminated structure according to claim 1, wherein the amount of silicon atoms present in said moniliform silica strings is 15% or more, based on the total number of silicon atoms present in said at least one porous silica layer.

4. The silica-containing laminated structure according to claim 1, wherein a part or all of said pores (P) have their respective pore opening areas (a₁), each of said pore opening areas (a₁) being independently at least 3σ larger than the average value (a₂) of the respective maximum cross-sectional areas of said primary silica particles, wherein said pore opening areas (a₁) are measured with respect to the pore openings in the surface or cross-section of said porous silica layer, and wherein a represents the standard deviation of the measured values of the maximum cross-sectional areas of said primary silica particles, and
wherein the total (S_{(a2+3σ)}) of said pore opening areas (a₁) of said pores (P) and the total (S) of pore opening areas of all pores of said porous silica layer as measured with respect to the pore openings in the surface or cross-section of said porous silica layer satisfy the following formula (1):
(S_{(a2+3σ)})/(S)≧0.5 (1).

5. The silica-containing laminated structure according to claim 1, wherein said transparent thermoplastic resin substrate has a pencil hardness of from 1H to 8H.

6. The silica-containing laminated structure according to claim 1, which further comprises a hard coat layer having a water contact angle of 85° or less between said transparent thermoplastic resin substrate and said porous silica layer.

7. A coating composition for use in forming on a substrate a porous silica layer having a low refractivity, which comprises a product obtained by a method comprising:
mixing a dispersion of moniliform silica strings with a hydrolyzable group-containing silane to obtain a mixture, wherein each of said moniliform silica strings comprises a plurality of primary silica particles which are linked in rosary form, and
subjecting the obtained mixture to hydrolysis and dehydration-condensation.

8. The coating composition according to claim 7, wherein said moniliform silica strings have an average length of from 30 to 200 nm in terms of the average value as measured by the dynamic light scattering method.

9. The coating composition according to claim 7, wherein the molar ratio of said hydrolyzable group-containing silane to the silicon atoms present in said moniliform silica strings is from 0.005 to 1.0.

10. The coating composition according to claim 7, which further comprises at least one alkaline earth metal salt.

11. The coating composition according to claim 10, wherein the molar ratio of said at least one alkaline earth metal salt to the silicon atoms present in said moniliform silica strings is from 0.001 to 0.1.

12. The coating composition according to claim 7, which further comprises an acid in a concentration of 0.0008 mol/liter or more, and which has a water content of more than 1.5 parts by weight, per part by weight of said moniliform silica strings.

13. An antireflection film comprising at least one porous silica layer having a low refractivity, which is formed by using the coating composition of any one of claims 7 to 12.

14. An antireflection film comprising a silica-containing laminated structure comprising a transparent thermoplastic resin substrate and, laminated thereon, at least one porous silica layer having a refractive index of 1.22 or more and less than 1.30,
wherein said at least one porous silica layer is comprised of a plurality of moniliform silica strings, each comprising a plurality of primary silica particles which are linked in rosary form, and
wherein the pores of said at least one porous silica layer include pores (P), each of said pores (P) having a pore opening area which is larger than the average value of the respective maximum cross-sectional areas of said primary silica particles, wherein said pore opening areas of said pores (P) are measured with respect to the pore openings in the surface or cross-section of said porous silica layer, and
wherein said at least one porous silica layer contained in said silica-containing laminated structure is formed by using the coating composition of claims 7 to 12.

15. An antireflection film comprising a silica-containing laminated structure comprising a transparent thermoplastic resin substrate and, laminated thereon, at least one porous silica layer having a refractive index of 1.22 or more and less than 1.30,
wherein said at least one porous silica layer is comprised of a plurality of moniliform silica strings, each comprising a plurality of primary silica particles which are linked in rosary form,
wherein the pores of said at least one porous silica layer include pores (P), each of said pores (P) having a pore opening area which is larger than the average value of the respective maximum cross-sectional areas of said primary silica particles, wherein said pore opening areas of said pores (P) are measured with respect to the pore openings in the surface or cross-section of said porous silica layer,
wherein a part or all of said pores (P) have their respective pore opening areas (a₁), each of said pore opening areas (a₁) being independently at least 3σ larger than the average value (a₂) of the respective maximum cross-sectional areas of said primary silica particles, wherein said pore opening areas (a₁) are measured with respect to the pore openings in the surface or cross-section of said porous silica layer, and wherein σ represents the standard deviation of the measured values of the maximum cross-sectional areas of said primary silica particles,
wherein the total (S_{(a2+3σ)}) of said pore opening areas (a₁) of said pores (P) and the total (S) of pore opening areas of all pores of said porous silica layer as measured with respect to the pore openings in the surface or cross-section of said porous silica layer satisfy the following formula (1):
(S_{(a2+3σ)})/(S)≧0.5 (1), and
wherein said at least one porous silica layer contained in said silica-containing laminated structure is formed by using the coating composition of claims 7 to 12.
